(19) United States
(12) Patent Application Publication
(10) Pub. No.: US 2026/0353091 A1
(43) Pub. Date: Nov. 5, 2026

(54) BLUETOOTH COMMUNICATION METHOD, APPARATUS, AND SYSTEM, STORAGE MEDIUM, AND ELECTRONIC DEVICE

(71) Applicant: BEIJING SMARTCHIP MICROELECTRONICS TECHNOLOGY COMPANY LIMITED, Beijing (CN)

(72) Inventors: Fan Jiang, Beijing (CN); Fei Guo, Beijing (CN); Jun Du, Beijing (CN); Wei Meng, Beijing (CN); Qingquan Wang, Beijing (CN); Xiaokui Xing, Beijing (CN); Jianwei Chen, Beijing (CN); Ran An, Beijing (CN); Naichong Fan, Beijing (CN); Shukun Li, Beijing (CN)

(21) Appl. No.: 18/868,178

(22) PCT Filed: Jul. 10, 2024
(86) PCT No.: PCT/CN2024/104586

§ 371 Date: Nov. 22, 2024

(30) Foreign Application Priority Data
Nov. 15, 2023 (CN) 202311518933.5

(51) Int. Cl. H04W 12/50; H04B 1/7136; H04L 9/08; H04W 12/037; H04W 12/041; H04W 12/069; H04W 72/563; H04W 76/10

(52) U.S. Cl. CPC H04W 12/50; H04B 1/7136; H04L 9/0869; H04W 12/037; H04W 12/041; H04W 12/069; H04W 72/563; H04W 76/10; H04B 2201/71346

(57) ABSTRACT

Provided are a Bluetooth communication method, apparatus, and system, a storage medium, and an electronic device. The Bluetooth communication method includes: obtaining a cipher resource application sent by a source Bluetooth device, where the cipher resource application includes information about the source Bluetooth device and a destination Bluetooth device, and random numbers; performing matching in preset application keys of Bluetooth devices based on the information about the source Bluetooth device and the destination Bluetooth device, to find an application key of the source Bluetooth device and an application key of the destination Bluetooth device; generating a cipher resource based on the application key of the source Bluetooth device, the application key of the destination Bluetooth device, and the random numbers, where the cipher resource is used to generate a private address; and separately delivering the cipher resource to the source and destination Bluetooth devices through encryption and signing.

### TECHNICAL FIELD

The present disclosure relates to the field of communication technologies, and in particular, to a Bluetooth communication method, a Bluetooth communication apparatus, a Bluetooth communication system, a machine-readable storage medium, and an electronic device.

### BACKGROUND

Bluetooth is a typical communication technology for Internet of Things communication, and Bluetooth communication may be applied to a plurality of application scenarios such as a smart home scenario and an electric power application scenario as a local communication manner.

However, a Media Access Control (MAC) address in conventional Bluetooth communication is usually fixed. Consequently, Bluetooth impersonation attacks of Bluetooth addresses occur. In other words, a malicious node uses a protocol to design and implement a vulnerability to fake a trusted device, causing security threats such as network identity forgery and data redirection. An attacker may identify and attack a device by monitoring and analyzing Bluetooth communication traffic. In addition, as a standard communication protocol, a Bluetooth protocol has a security vulnerability, and a Bluetooth device performs an identity verification and encryption operation in a pairing process. However, if a security problem exists in the pairing process, a hacker may obtain an encryption key in the pairing process by using a means such as a man-in-the-middle attack, so as to monitor and decrypt Bluetooth communication data, and this causes a data leakage risk.

Therefore, there is a communication security problem in existing Bluetooth communication.

### SUMMARY

Embodiments of the present disclosure are to provide a Bluetooth communication method, a Bluetooth communication apparatus, a Bluetooth communication system, a machine-readable storage medium, and an electronic device. In the Bluetooth communication method, different private addresses may be generated in each communication, thereby reducing a risk of being attacked and ensuring the security of Bluetooth communication.

To implement the above objective, a first aspect of the present disclosure provides a Bluetooth communication method, applied to a cipher resource management system, where the Bluetooth communication method includes:
obtaining a cipher resource application sent by a source Bluetooth device, where the cipher resource application includes information about the source Bluetooth device, information about a destination Bluetooth device, and a plurality of random numbers;
performing matching in preset application keys of a plurality of Bluetooth devices based on the information about the source Bluetooth device and the information about the destination Bluetooth device, to find an application key of the source Bluetooth device and an application key of the destination Bluetooth device;
generating a cipher resource based on the application key of the source Bluetooth device, the application key of the destination Bluetooth device, and the plurality of random numbers;
encrypting the cipher resource separately by using the application key of the source Bluetooth device and the application key of the destination Bluetooth device, to obtain a first cipher resource ciphertext and a second cipher resource ciphertext;
separately signing the first cipher resource ciphertext and the second cipher resource ciphertext based on a preset master station private key, to generate a first signature and a second signature; and
delivering the first signature and the first cipher resource ciphertext to the source Bluetooth device, and delivering the second signature and the second cipher resource ciphertext to the destination Bluetooth device, so that the source Bluetooth device and the destination Bluetooth device perform Bluetooth communication based on the cipher resource; where
the cipher resource is used to generate a private address.

In embodiments of the present disclosure, secure chip sequence numbers of a plurality of Bluetooth devices are preset in the cipher resource management system, the plurality of random numbers include a first random number, a second random number, and a third random number, and the cipher resource includes a Z-algorithm instance, a temporary key, and a session key; and
the generating the cipher resource based on the application key of the source Bluetooth device, the application key of the destination Bluetooth device, and the plurality of random numbers includes:
performing key derivation on the application key of the source Bluetooth device based on the first random number to obtain a temporary key K1;
performing key derivation on the application key of the destination Bluetooth device based on the second random number to obtain a temporary key K2;
generating a Z-algorithm instance Z1 based on the temporary key K1 by using a Z-cipher algorithm, and generating a Z-algorithm instance Z2 based on the temporary key K2 by using the Z-cipher algorithm;
performing key derivation on the application key of the source Bluetooth device based on a secure chip sequence number of the destination Bluetooth device and the third random number to obtain the session key; and
obtaining the cipher resource based on the temporary key K1, the temporary key K2, the Z-algorithm instance Z1, the Z-algorithm instance Z2, and the session key.

In embodiments of the present disclosure, a process of obtaining the preset application keys of the plurality of Bluetooth devices includes:
obtaining the plurality of Bluetooth devices through registration, and separately obtaining secure chip information of the Bluetooth devices, where the secure chip information includes at least the secure chip sequence numbers; and
performing key derivation on the secure chip sequence numbers of the Bluetooth devices based on a preset service root key, to obtain the application keys of the plurality of Bluetooth devices.

A second aspect of the present disclosure provides a Bluetooth communication method, applied to a source Bluetooth device and including:
obtaining a first cipher resource ciphertext and a first signature, where the first cipher resource ciphertext and the first signature are obtained by using the above Bluetooth communication method applied to the cipher resource management system; and
verifying the first signature by using a preset master station certificate, and decrypting the first cipher resource ciphertext by using a preset application key of the source Bluetooth device when the verification on the first signature succeeds, to obtain a cipher resource; and
performing Bluetooth communication with a destination Bluetooth device based on the cipher resource.

In embodiments of the present disclosure, the cipher resource includes a Z-algorithm instance, a temporary key, and a session key; and
the performing Bluetooth communication with the destination Bluetooth device based on the cipher resource includes:
constructing a private address based on the Z-algorithm instance and the temporary key in the cipher resource; and
performing Bluetooth communication with the destination Bluetooth device based on the private address by using the session key in the cipher resource.

In embodiments of the present disclosure, the temporary key includes a temporary key K1 and a temporary key K2, and the Z-algorithm instance includes a Z-algorithm instance Z1 and a Z-algorithm instance Z2; and
the constructing the private address based on the Z-algorithm instance and the temporary key in the cipher resource includes:
obtaining current local time and a region code, and generating a timestamp based on the current local time;
encrypting, based on the temporary key K1 and the Z-algorithm instance Z1, a random code formed by the timestamp and the region code, to obtain an address encryption ciphertext of the source Bluetooth device;
encrypting, based on the temporary key K2 and the Z-algorithm instance Z2, the random code formed by the timestamp and the region code, to obtain an address encryption ciphertext of the destination Bluetooth device;
constructing a private address of the source Bluetooth device based on the address encryption ciphertext of the source Bluetooth device, the timestamp, and the region code; and
constructing a private address of the destination Bluetooth device based on the address encryption ciphertext of the destination Bluetooth device, the timestamp, and the region code.

In embodiments of the present disclosure, the performing Bluetooth communication with the destination Bluetooth device based on the private address by using the session key in the cipher resource includes:
sending a connection establishment request to the destination Bluetooth device based on the private address of the source Bluetooth device and the private address of the destination Bluetooth device;
when the connection establishment request is successfully sent, obtaining a to-be-verified private address sent by the destination Bluetooth device; and
verifying validity of the to-be-verified private address based on the cipher resource, and performing Bluetooth communication with the destination Bluetooth device by using the session key in the cipher resource when the verification succeeds.

In embodiments of the present disclosure, the performing Bluetooth communication with the destination Bluetooth device by using the session key in the cipher resource when the verification succeeds includes:
performing dynamic session key negotiation with the destination Bluetooth device by using the session key in the cipher resource, to obtain a temporary session key; and
establishing a secure communication channel based on the temporary session key, to perform Bluetooth communication.

In embodiments of the present disclosure, after the establishing the secure communication channel, the method further includes:
obtaining a local channel state, and constructing a channel map and a channel priority table based on the local channel state; and
obtaining service information of the source Bluetooth device, and constructing a service priority table based on a service level and a priority of the source Bluetooth device.

In embodiments of the present disclosure, the method further includes:
sending the channel map and the channel priority table to all Bluetooth devices in a network through broadcasting.

In embodiments of the present disclosure, the method further includes:
selecting a data channel based on a channel selection algorithm;
obtaining current channel state information and current service information by using the data channel;
comparing the current channel state information with the channel priority table to obtain a priority of a current channel; and
switching between service channels based on the priority of the current channel, the service priority table, and the current service information, to obtain a most appropriate channel.

In embodiments of the present disclosure, the switching between the service channels based on the priority of the current channel, the service priority table, and the current service information, to obtain the most appropriate channel includes:
obtaining a current service priority by querying the service priority table based on the current service information;
determining whether the current service priority matches the priority of the current channel; and
if it is determined that the current service priority matches the priority of the current channel, performing communication by using the current channel; or
if it is determined that the current service priority does not match the priority of the current channel, selecting a channel that matches the current service priority from the channel priority table, and performing communication by using the channel.

In embodiments of the present disclosure, the method further includes:
periodically obtaining a channel state, and updating the channel priority table based on the channel state to obtain a new channel priority table; and
broadcasting the new channel priority table, so that a connected Bluetooth device dynamically adjusts a frequency hopping channel based on the new channel priority table.

In embodiments of the present disclosure, the method further includes:
in a communication process, determining, based on a size of an exchanged data packet, whether to perform dynamic slot adjustment on current communication; and
when the size of the exchanged data packet is greater than a preset threshold, adjusting, based on a current service priority, a ratio of slots used for the current communication, to implement dynamic slot adjustment.

In embodiments of the present disclosure, the adjusting, based on the current service priority, the ratio of the slots used for the current communication, to implement dynamic slot adjustment includes:
generating a plurality of service weights based on the current service priority and the service priority table; and
adjusting, based on a ratio of each service weight, the ratio of the slots used for the current communication, to implement dynamic slot adjustment.

In embodiments of the present disclosure, the adjusting, based on the ratio of each service weight, the ratio of the slots used for the current communication includes:
initializing a total slot length;
separately calculating an adjusted slot length of each connection based on the ratio of each service weight and the total slot length; and
updating a slot of each connection in the current communication based on the adjusted slot length of each connection, to adjust the ratio of the slots used for the current communication.

A third aspect of the present disclosure provides a Bluetooth communication method, applied to a destination Bluetooth device and including:
obtaining a second cipher resource ciphertext and a second signature, where the second cipher resource ciphertext and the second signature are obtained by using the above Bluetooth communication method applied to the cipher resource management system;
verifying the second signature by using a preset master station certificate, and decrypting the second cipher resource ciphertext by using a preset application key of the destination Bluetooth device when the verification on the second signature succeeds, to obtain a cipher resource; and
performing Bluetooth communication with a source Bluetooth device based on the cipher resource.

In embodiments of the present disclosure, the cipher resource includes a Z-algorithm instance, a temporary key, and a session key; and
the performing Bluetooth communication with the source Bluetooth device based on the cipher resource includes:
constructing a private address based on the Z-algorithm instance and the temporary key in the cipher resource; and
performing Bluetooth communication with the source Bluetooth device based on the private address by using the session key in the cipher resource.

In embodiments of the present disclosure, the temporary key includes a temporary key K1 and a temporary key K2, and the Z-algorithm instance includes a Z-algorithm instance Z1 and a Z-algorithm instance Z2; and
the constructing the private address based on the Z-algorithm instance and the temporary key in the cipher resource includes:
obtaining current local time and a region code, and generating a timestamp based on the current local time;
encrypting, based on the temporary key K1 and the Z-algorithm instance Z1, a random code formed by the timestamp and the region code, to obtain an address encryption ciphertext of the source Bluetooth device;
encrypting, based on the temporary key K2 and the Z-algorithm instance Z2, the random code formed by the timestamp and the region code, to obtain an address encryption ciphertext of the destination Bluetooth device;
constructing a private address of the source Bluetooth device based on the address encryption ciphertext of the source Bluetooth device, the timestamp, and the region code; and
constructing a private address of the destination Bluetooth device based on the address encryption ciphertext of the destination Bluetooth device, the timestamp, and the region code.

In embodiments of the present disclosure, the performing Bluetooth communication with the source Bluetooth device based on the private address by using the session key in the cipher resource includes:
obtaining, in response to a connection establishment request sent by the source Bluetooth device, a to-be-verified private address sent by the source Bluetooth device; and
verifying validity of the to-be-verified private address based on the cipher resource, and performing Bluetooth communication with the source Bluetooth device by using the session key in the cipher resource when the verification succeeds.

In embodiments of the present disclosure, the performing Bluetooth communication with the source Bluetooth device by using the session key in the cipher resource when the verification succeeds includes:
performing dynamic session key negotiation with the source Bluetooth device by using the session key in the cipher resource, to obtain a temporary session key; and
establishing a secure communication channel based on the temporary session key, to perform Bluetooth communication.

In embodiments of the present disclosure, after the establishing the secure communication channel, the method further includes:
obtaining a local channel state, and constructing a channel map and a channel priority table based on the local channel state;
obtaining service information of the destination Bluetooth device, and constructing a service priority table based on a service level and a priority of the destination Bluetooth device.

In embodiments of the present disclosure, the method further includes:
sending the channel map and the channel priority table to all Bluetooth devices in a network through broadcasting.

In embodiments of the present disclosure, the method further includes:
periodically obtaining a channel state, and updating the channel priority table based on the channel state to obtain a new channel priority table; and
broadcasting the new channel priority table, so that a connected Bluetooth device dynamically adjusts a frequency hopping channel based on the new channel priority table.

A fourth aspect of the present disclosure provides a Bluetooth communication system, including a cipher resource management system, a source Bluetooth device, and a destination Bluetooth device; where
the source Bluetooth device is configured to send a cipher resource application to the cipher resource management system, where the cipher resource application includes information about the source Bluetooth device, information about the destination Bluetooth device, and a plurality of random numbers; and
the cipher resource management system is configured to: perform matching in preset application keys of a plurality of Bluetooth devices based on the information about the source Bluetooth device and the information about the destination Bluetooth device, to find an application key of the source Bluetooth device and an application key of the destination Bluetooth device; generate a cipher resource based on the application key of the source Bluetooth device, the application key of the destination Bluetooth device, and the plurality of random numbers; encrypt the cipher resource separately by using the application key of the source Bluetooth device and the application key of the destination Bluetooth device, to obtain a first cipher resource ciphertext and a second cipher resource ciphertext; separately sign the first cipher resource ciphertext and the second cipher resource ciphertext based on a preset master station private key, to generate a first signature and a second signature; and deliver the first signature and the first cipher resource ciphertext to the source Bluetooth device, and deliver the second signature and the second cipher resource ciphertext to the destination Bluetooth device, so that the source Bluetooth device and the destination Bluetooth device perform Bluetooth communication based on the cipher resource; where the cipher resource is used to generate a private address.

A fifth aspect of the present disclosure provides a Bluetooth communication apparatus, applied to a cipher resource management system, where the Bluetooth communication apparatus includes:
an obtaining module configured to obtain a cipher resource application sent by a source Bluetooth device, where the cipher resource application includes information about the source Bluetooth device, information about a destination Bluetooth device, and a plurality of random numbers.
an application key matching module configured to perform matching in preset application keys of a plurality of Bluetooth devices based on the information about the source Bluetooth device and the information about the destination Bluetooth device, to find an application key of the source Bluetooth device and an application key of the destination Bluetooth device.
a cipher resource generation module configured to generate a cipher resource based on the application key of the source Bluetooth device, the application key of the destination Bluetooth device, and the plurality of random numbers;
a first encryption module configured to encrypt the cipher resource separately by using the application key of the source Bluetooth device and the application key of the destination Bluetooth device, to obtain a first cipher resource ciphertext and a second cipher resource ciphertext, where the cipher resource is used to generate a private address;
a first signing module configured to separately sign the first cipher resource ciphertext and the second cipher resource ciphertext based on a preset master station private key, to generate a first signature and a second signature; and
a delivering module configured to: deliver the first signature and the first cipher resource ciphertext to the source Bluetooth device, and delivering the second signature and the second cipher resource ciphertext to the destination Bluetooth device, so that the source Bluetooth device and the destination Bluetooth device perform Bluetooth communication based on the cipher resource.

In embodiments of the present disclosure, secure chip sequence numbers of a plurality of Bluetooth devices are preset in the cipher resource management system, the plurality of random numbers include a first random number, a second random number, and a third random number, and the cipher resource includes a Z-algorithm instance, a temporary key, and a session key; and
the cipher resource generation module includes:
a first key derivation unit configured to perform key derivation on the application key of the source Bluetooth device based on the first random number to obtain a temporary key K1;
a second key derivation unit configured to perform key derivation on the application key of the destination Bluetooth device based on the second random number to obtain a temporary key K2;
an algorithm instance unit configured to: generate a Z-algorithm instance Z1 based on the temporary key K1 by using a Z-cipher algorithm, and generate a Z-algorithm instance Z2 based on the temporary key K2 by using the Z-cipher algorithm;
a third key derivation unit configured to perform key derivation on the application key of the source Bluetooth device based on a secure chip sequence number of the destination Bluetooth device and the third random number, to obtain a session key; and
a resource generation unit configured to obtain the cipher resource based on the temporary key K1, the temporary key K2, the Z-algorithm instance Z1, the Z-algorithm instance Z2, and the session key.

A sixth aspect of the present disclosure provides a Bluetooth communication apparatus, applied to a source Bluetooth device and including:
a first cipher resource obtaining module configured to obtain a first cipher resource ciphertext and a first signature, where the first cipher resource ciphertext and the first signature are obtained by using the above Bluetooth communication apparatus applied to the cipher resource management system; and
a first signature verification module configured to: verify the first signature by using a preset master station certificate, and decrypt the first cipher resource ciphertext by using a preset application key of the source Bluetooth device when the verification on the first signature succeeds, to obtain a cipher resource; and
a first Bluetooth communication module configured to perform Bluetooth communication with a destination Bluetooth device based on the cipher resource.

A seventh aspect of the present disclosure provides a Bluetooth communication apparatus, applied to a destination Bluetooth device and including:
a second cipher resource obtaining module configured to obtain a second cipher resource ciphertext and a second signature, where the second cipher resource ciphertext and the second signature are obtained by using the above Bluetooth communication apparatus applied to the cipher resource management system; and
a second signature verification module configured to: verify the second signature by using a preset master station certificate, and decrypt the second cipher resource ciphertext by using a preset application key of the destination Bluetooth device when the verification on the second signature succeeds, to obtain a cipher resource; and
a second Bluetooth communication module configured to perform Bluetooth communication with a source Bluetooth device based on the cipher resource.

An eighth aspect of the present disclosure provides an electronic device, and the electronic device includes:
at least one processor; and
a memory connected to the at least one processor; where
the memory stores an instruction that can be executed by the at least one processor, and the at least one processor executes the instruction stored in the memory to implement the above Bluetooth communication method.

A ninth aspect of the present disclosure provides a machine-readable storage medium. The machine-readable storage medium stores an instruction, and when the instruction is executed by a processor, the processor is configured to perform the above Bluetooth communication method.

In the above technical solution, a cipher resource application sent by a source Bluetooth device is obtained from a cipher resource management system, where the cipher resource application includes the source Bluetooth device, a destination Bluetooth device, and a plurality of random numbers; matching is performed in preset application keys of a plurality of Bluetooth devices based on information about the source Bluetooth device and information about the destination Bluetooth device, to find an application key of the source Bluetooth device and an application key of the destination Bluetooth device; a cipher resource is generated based on the application key of the source Bluetooth device, the application key of the destination Bluetooth device, and the plurality of random numbers, where the cipher resource is used to generate a private address; the cipher resource is encrypted separately by using the application key of the source Bluetooth device and the application key of the destination Bluetooth device, to obtain a first cipher resource ciphertext and a second cipher resource ciphertext; the first cipher resource ciphertext and the second cipher resource ciphertext are separately signed based on a preset master station private key, to generate a first signature and a second signature; and the first signature and the first cipher resource ciphertext are delivered to the source Bluetooth device, and the second signature and the second cipher resource ciphertext are delivered to the destination Bluetooth device, so that the source Bluetooth device and the destination Bluetooth device perform Bluetooth communication based on the cipher resource. The cipher resource is obtained based on the random numbers and the application keys. Random numbers differ in each communication, and therefore, different cipher resources are obtained, so that different private addresses are generated in each communication, thereby reducing a risk of being attacked, and ensuring the security of Bluetooth communication. Through encryption and signing of the cipher resource, the confidentiality and the integrity of transmission of the cipher resource are ensured. A MAC address of conventional Bluetooth is usually allocated by a device manufacturer, and MAC addresses of different devices may conflict with each other, resulting in a communication fault. In the present disclosure, the cipher resource is uniformly generated by using the cipher resource management system, so that this conflict can be avoided, and compatibility and communication stability between devices can be improved. MAC addresses of conventional Bluetooth are limited. When a quantity of devices increases, the addresses may be insufficient. The cipher resource management system generates the cipher resource temporarily based on a service application. The cipher resource is released immediately after the service application expires. Theoretically, infinite device connections are supported.

Other features and advantages of embodiments of the present disclosure are described in detail in the subsequent description of embodiments part.

### BRIEF DESCRIPTION OF THE DRAWINGS

The accompanying drawings are provided for further understanding of the embodiments of the present disclosure, and constitute a part of the specification. The accompanying drawings and the following specific implementations are intended to explain the embodiments of the present disclosure, rather than to limit the embodiments of the present disclosure. In the accompanying drawings:

FIG. 1 schematically shows a schematic diagram of an application scenario of operation and maintenance of Z-algorithm Bluetooth electric power according to an embodiment of the present disclosure;

FIG. 2 schematically shows a schematic flowchart of a Bluetooth communication method applied to a cipher resource management system according to an embodiment of the present disclosure;

FIG. 3 schematically shows a schematic diagram of an architecture of a Z-algorithm cipher resource management system according to an embodiment of the present disclosure;

FIG. 4 schematically shows a flowchart of generation and distribution of a Z-algorithm instance and a session key according to an embodiment of the present disclosure;

FIG. 5 schematically shows a diagram of a process of generating a private address according to an embodiment of the present disclosure;

FIG. 6 schematically shows a diagram of a process of verifying a private address according to an embodiment of the present disclosure;

FIG. 7 schematically shows a diagram of an architecture of generation of a Bluetooth private address according to an embodiment of the present disclosure;

FIG. 8 schematically shows a schematic diagram of an operation and maintenance solution according to an embodiment of the present disclosure;

FIG. 9 schematically shows a diagram of a software architecture of a Bluetooth management application according to an embodiment of the present disclosure;

FIG. 10 schematically shows a process of establishing a secure communication channel according to an embodiment of the present disclosure;

FIG. 11 schematically shows a schematic diagram of an application scenario of operation and maintenance of intelligent power distribution according to an embodiment of the present disclosure;

FIG. 12 schematically shows a schematic diagram of an application scenario of home Bluetooth according to an embodiment of the present disclosure;

FIG. 13 schematically shows a schematic diagram of an application scenario of a multi-master multi-slave Bluetooth network according to an embodiment of the present disclosure;

FIG. 14 schematically shows a control flowchart according to an embodiment of the present disclosure;

FIG. 15 schematically shows a flowchart of generating a channel priority table according to an embodiment of the present disclosure;

FIG. 16 schematically shows a schematic flowchart of a Bluetooth communication method applied to a source Bluetooth device according to an embodiment of the present disclosure;

FIG. 17 schematically shows a schematic flowchart of a Bluetooth communication method applied to a destination Bluetooth device according to an embodiment of the present disclosure;

FIG. 18 schematically shows a block diagram of a structure of a Bluetooth communication apparatus applied to a cipher resource management system according to an embodiment of the present disclosure;

FIG. 19 schematically shows a block diagram of a structure of a Bluetooth communication apparatus applied to a source Bluetooth device according to an embodiment of the present disclosure;

FIG. 20 schematically shows a block diagram of a structure of a Bluetooth communication apparatus applied to a destination Bluetooth device according to an embodiment of the present disclosure; and

FIG. 21 schematically shows a diagram of an internal structure of a computer device according to an embodiment of the present disclosure.

### DESCRIPTION OF REFERENCE NUMERALS

510-Obtaining module; 520-Application key matching module; 530-Cipher resource generation module; 540-First encryption module; 550-First signing module; 560-Delivering module; 610-First cipher resource obtaining module; 620-First signature verification module; 630-First Bluetooth communication module; 710-Second cipher resource obtaining module; 720-Second signature verification module; 730-Second Bluetooth communication module; A01-Processor; A02-Network interface; A03-Internal memory; A04-Display; A05-Input apparatus; A06-Non-volatile storage medium; B01-Operating system; B02-Computer program.

### Detailed Description of the Embodiments

Specific implementations of the embodiments of the present disclosure are described in detail below with reference to the accompanying drawings. It should be understood that the specific implementations described herein are merely intended to illustrate and interpret the embodiments of the present disclosure, rather than to limit the embodiments of the present disclosure.

It should be noted that, if descriptions such as “first” and “second” are involved in the embodiments of the present disclosure, the descriptions such as “first” and “second” are used only for the purpose of description and are not intended to indicate or imply relative importance, or implicitly indicate a quantity of indicated technical features. Therefore, features defined by “first” and “second” may explicitly or implicitly include at least one of the features. Furthermore, the technical solutions between the various embodiments may be combined with each other, but must be on the basis that the combination thereof can be implemented by a person of ordinary skill in the art. In case of a contradiction with the combination of the technical solutions or a failure to implement the combination, it should be considered that the combination of the technical solutions does not exist, and is not within the protection scope of the present disclosure.

In the embodiments, a design idea of deep fusion of a user key, an algorithm, and a task application is fully used, and a Bluetooth communication method is provided based on a uniform algorithm architecture according to an algorithm derivation rule (unified algorithm architecture+algorithm derivation rule) with reference to an application requirement, to ensure security of a cipher resource, Bluetooth address generation, access authentication, and a service data channel, and improve transmission efficiency and reliability of a wireless communication system.

It should be noted that the Bluetooth communication method in the embodiments may be applicable to various Bluetooth communication scenarios. To facilitate description of the solution, an application scenario of power operation and maintenance is mainly used as an example below for description.

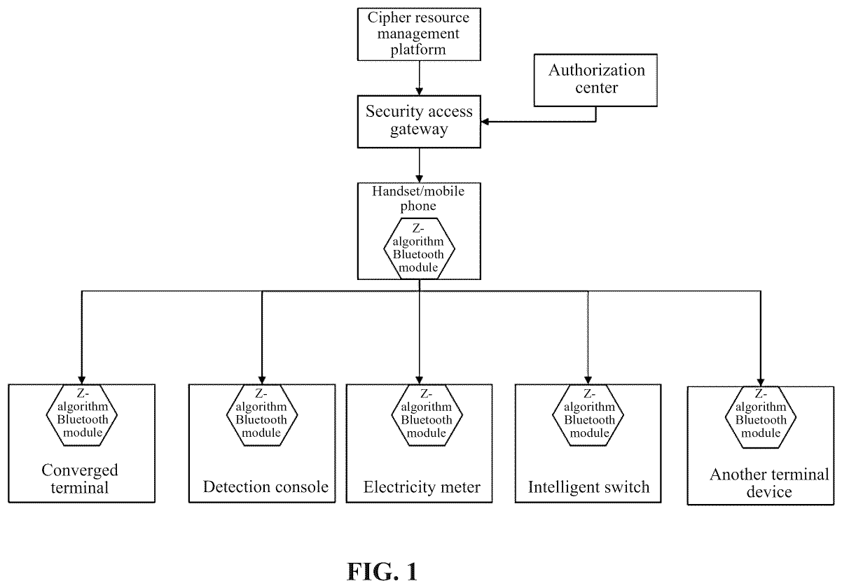

As shown in FIG. 1, FIG. 1 schematically shows a schematic diagram of an application scenario of operation and maintenance of Z-algorithm Bluetooth electric power according to an embodiment of the present disclosure. For an application scenario of power operation and maintenance, a handset/mobile phone obtains a cipher resource from a cipher resource management platform by using a security access gateway. The handset/mobile phone performs Bluetooth communication with a converged terminal, a detection console, an electricity meter, an intelligent switch, or another terminal device by using a Z-algorithm Bluetooth module. The Bluetooth communication method in the present disclosure may be used to implement the following functions: Security management: performing identity verification and access control on a device by using a Bluetooth connection, to prevent an unauthorized person from performing an operation. In addition, Bluetooth encrypts data and transmit the data in a secure manner to protect the security of device data. Device configuration and debugging: Bluetooth is used for device configuration and debugging, and operation and maintenance personnel connect to a device through Bluetooth, and configure, calibrate and debug parameters of the device through associated applications of the mobile phone/handset. Device monitoring and fault diagnosis: monitoring a running status and performance of an electric power device in real time by using a Bluetooth module installed on the device, collecting a current, a voltage collection amount, a device running status parameter, and the like, and transmitting data to a monitoring system through Bluetooth. Operation parameter reading and setting: An electric power device is remotely operated and controlled. Through a Bluetooth module connected to the equipment, operation and maintenance personnel use a mobile device such as a mobile phone/handset to remotely control on/off and a parameter of the equipment, thereby improving operation and maintenance efficiency and reducing operation risks.

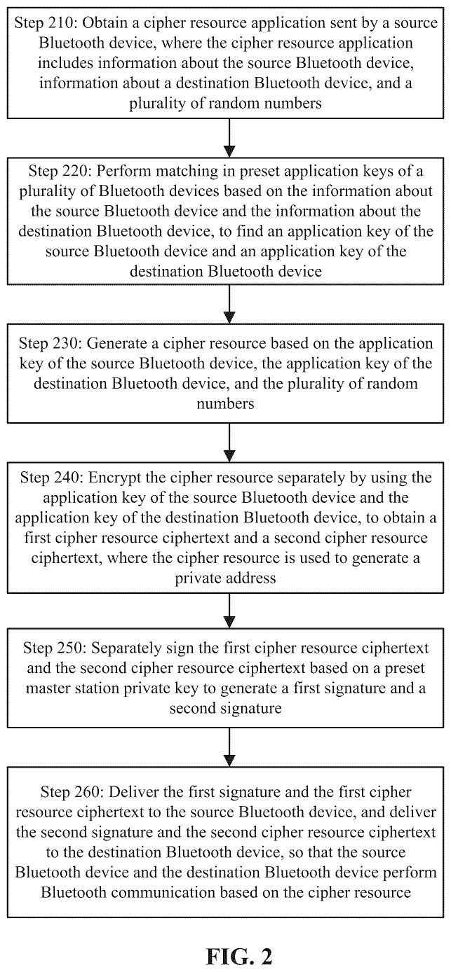

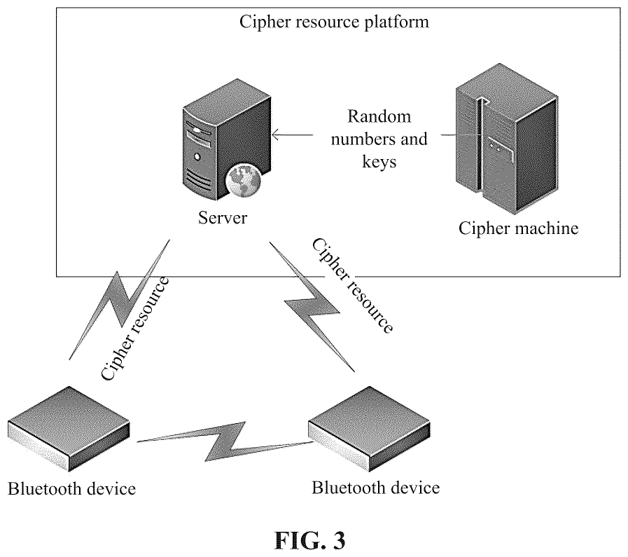

As shown in FIG. 2 and FIG. 3, FIG. 2 schematically shows a schematic flowchart of a Bluetooth communication method applied to a cipher resource management system according to an embodiment of the present disclosure, and FIG. 3 schematically shows a schematic diagram of an architecture of a Z-algorithm cipher resource management system according to an embodiment of the present disclosure. A cipher resource management system is disposed on a cipher resource platform in FIG. 3. A Bluetooth communication method is provided in this embodiment, and is applied to a cipher resource management system. The Bluetooth communication method includes the following steps:

In step 210, a cipher resource application sent by a source Bluetooth device is obtained, where the cipher resource application includes information about the source Bluetooth device, information about a destination Bluetooth device, and a plurality of random numbers.

In this embodiment, before initiating a communication connection, a Bluetooth device needs to first apply for a session key and a Z-algorithm instance from the cipher resource management platform, that is, send a cipher resource application. The Bluetooth device sets both an Internet Protocol (IP) address and a port of a cipher resource management system, to facilitate a connection to the cipher resource management system. The cipher resource management system manages a device and a Bluetooth module, including information such as a device area, time, a unique identifier, a device machine code, an identity document (ID) of a secure chip, and the Bluetooth module. The above information about the source Bluetooth device includes information such as a device ID and a device name, and correspondingly, the information about the destination Bluetooth device includes information such as a device ID and a device name. The above source Bluetooth device is a device that puts forward the cipher resource application, and the destination Bluetooth device is a Bluetooth device to which the source Bluetooth device wants to connect.

It should be noted that the above random number may be generated by a hardware random number generator, or may be a random number including a timestamp or an operation and maintenance area certificate. A manner of generating the random number is not limited in this embodiment.

In step 220, matching is performed in preset application keys of a plurality of Bluetooth devices based on the information about the source Bluetooth device and the information about the destination Bluetooth device, to find an application key of the source Bluetooth device and an application key of the destination Bluetooth device.

In this embodiment, the cipher resource management system pre-stores application keys of a plurality of Bluetooth device. After the cipher resource application is obtained, corresponding application keys may be separately obtained through matching based on the information about the source Bluetooth device and the information about the destination Bluetooth device in the cipher resource application. Correspondingly, the application keys may also be written into Bluetooth devices in advance.

In some embodiments, a process of obtaining the preset application keys of the plurality of Bluetooth device includes the following:

First, the plurality of Bluetooth devices are obtained through registration, and secure chip information of the Bluetooth devices is separately obtained, where the secure chip information includes at least a secure chip sequence number.

Then, key derivation is separately performed on secure chip sequence numbers of the Bluetooth devices based on a preset service root key, to obtain the application keys of the plurality of Bluetooth devices.

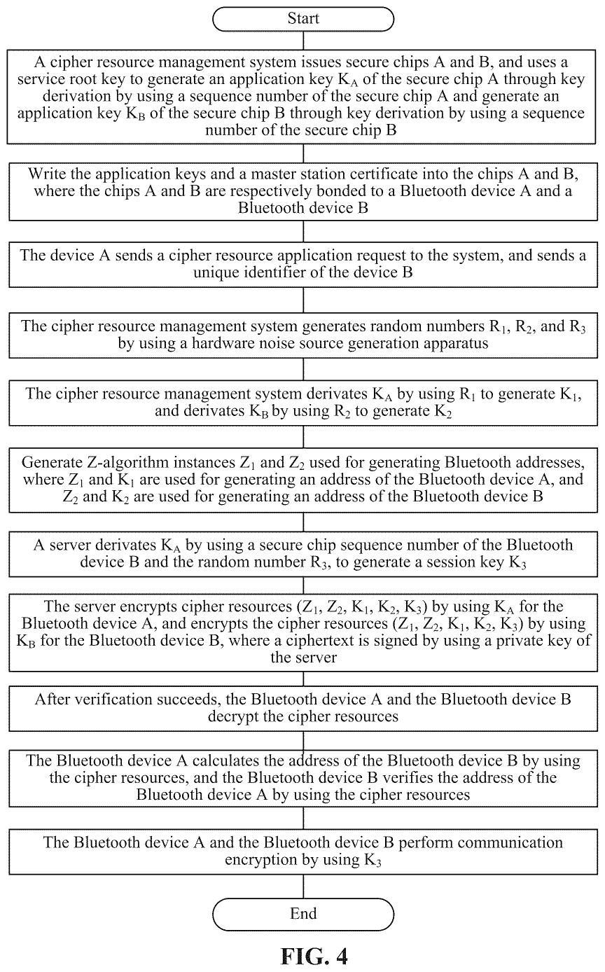

In this embodiment, a secure chip is an apparatus that can independently generate and encrypt and decrypt a key, and has an independent processor and an independent storage unit on an inner side, and can store a key and characteristic data. Encryption is performed by using the secure chip. The key is stored in hardware, and stolen data cannot be decrypted, to protect commercial privacy and data security. As shown in FIG. 4, FIG. 4 schematically shows a flowchart of generation and distribution of a Z-algorithm instance and a session key according to an embodiment of the present disclosure. A Bluetooth device A and a Bluetooth device B are used as an example. A secure chip A is disposed in the Bluetooth device A, and a secure chip B is disposed in the Bluetooth device B. The cipher resource management system issues the secure chips A and B, uses a service root key to generate an application key of the secure chip A through key derivation by using a sequence number of the secure chip A and generate an application key of the secure chip B through key derivation by using a sequence number of the secure chip B, and delivers a master station certificate to the secure chips, registers the Bluetooth device A and the Bluetooth device B with the cipher resource management system, binds the secure chip A to the Bluetooth device A, and binds the secure chip B to the Bluetooth device B.

It should be noted that all key derivation mentioned in this embodiment refers to performing key derivation by using a key derivation algorithm, and belongs to the prior art, and details are not described herein again.

In step 230, a cipher resource is generated based on the application key of the source Bluetooth device, the application key of the destination Bluetooth device, and the plurality of random numbers.

In some embodiments, secure chip sequence numbers of a plurality of Bluetooth devices are preset in the cipher resource management system, the plurality of random numbers include a first random number, a second random number, and a third random number, and the cipher resource includes a Z-algorithm instance, a temporary key, and a session key.

The generating the cipher resource based on the application key of the source Bluetooth device, the application key of the destination Bluetooth device, and the plurality of random numbers includes:

First, key derivation is performed on the application key of the source Bluetooth device based on the first random number, to obtain a temporary key K1.

Then, key derivation is performed on the application key of the destination Bluetooth device based on the second random number, to obtain a temporary key K2.

Then, a Z-algorithm instance Z1 is generated based on the temporary key K1 by using a Z-cipher algorithm, and a Z-algorithm instance Z2 is generated based on the temporary key K2 by using the Z-cipher algorithm.

Then, key derivation is performed on the application key of the source Bluetooth device based on the secure chip sequence number of the destination Bluetooth device and the third random number, to obtain a session key.

Finally, the cipher resource is obtained based on the temporary key K1, the temporary key K2, the Z-algorithm instance Z1, the Z-algorithm instance Z2, and the session key.

In this embodiment, the Z-cipher algorithm is a symmetric encryption algorithm of China. Based on a grouping cipher structure thereof, the Z-cipher algorithm uses a non-linear S-box, a confusion function, and an iterative round function, and is characterized by a simple structure, high non-linearity, and a fast encryption speed. The Z-cipher algorithm adopts a design idea of deep fusion of a user key and an algorithm. Based on a unified algorithm architecture and an algorithm derivation rule (unified algorithm architecture+algorithm derivation rule), different grouping algorithms are provided for different users when driven by the user key. Each algorithm instance is a customized and personalized reversible cipher transformation.

For ease of describing the solution, a Bluetooth device A and a Bluetooth device B are used as examples, the Bluetooth device A serves as the source Bluetooth device, and the Bluetooth device B serves as the destination Bluetooth device. Random numbers R1, R2, and R3 may be generated by the hardware random number generator. The cipher resource management system retrieves information about the Bluetooth devices A and B; performs key derivation on the application key K_{A} by using the random number R1 to generate a temporary key K1, and performs key derivation on the application key K_{B} by using the random number R2 to generate a temporary key K2; separately generates, based on the temporary key K1 and the temporary key K2, a Z-algorithm instance Z1 and a Z-algorithm instance Z2 that are used to generate Bluetooth addresses, where the Z-algorithm instance Z1 and the temporary key K1 are used to generate a private address of the Bluetooth device A, and the Z-algorithm instance Z2 and the temporary key K2 are used to generate a private address of the Bluetooth device B; and performs key derivation on the application key K_{A} by using the secure chip sequence number of the Bluetooth device B and the random number R3, to generate a session key K3.

The cipher resource is delivered to the source Bluetooth device and the destination Bluetooth device, so that the source Bluetooth device and the destination Bluetooth device perform Bluetooth communication based on the cipher resource, where the cipher resource is used to generate a private address.

In this embodiment, after the cipher resource is obtained, the cipher resource management system delivers the cipher resource to the source Bluetooth device and the destination Bluetooth device, and the source Bluetooth device and the destination Bluetooth device generate private addresses based on the cipher resource to implement Bluetooth communication. The above delivering process may be direct delivery or may be delivery after encryption processing.

To ensure the confidentiality and the integrity of transmission of the cipher resource, delivery after encryption processing may be used for the delivering process. The delivering the cipher resource to the source Bluetooth device and the destination Bluetooth device, so that the source Bluetooth device and the destination Bluetooth device perform Bluetooth communication based on the cipher resource includes the following:

In step 240, the cipher resource is encrypted separately by using the application key of the source Bluetooth device and the application key of the destination Bluetooth device, to obtain a first cipher resource ciphertext and a second cipher resource ciphertext, where the cipher resource is used to generate a private address.

In step 250, the first cipher resource ciphertext and the second cipher resource ciphertext are separately signed based on a preset master station private key to generate a first signature and a second signature.

In step 260, the first signature and the first cipher resource ciphertext are delivered to the source Bluetooth device, and the second signature and the second cipher resource ciphertext are delivered to the destination Bluetooth device, so that the source Bluetooth device and the destination Bluetooth device perform Bluetooth communication based on the cipher resource.

In this embodiment, the preset master station private key is a private key written into the cipher resource management system in advance. For ease of description of the solution, the Bluetooth device A and the Bluetooth device B are used as examples, and the cipher resource is encrypted separately by using the application key K_{A} and the application key K_{B} (the cipher resource includes the Z-algorithm instance Z1, the Z-algorithm instance Z2, the temporary key K1, the temporary key K2, and the session key K3). An encryption process is as follows:
E1=Enc(K_{A}, Z1+Z2+K₁+K₂+K3), and
E2=Enc(K_{B}, Z1+Z2+K₁+K₂+K3), where

E1 is the first cipher resource ciphertext, E2 is the second cipher resource ciphertext, and Enc (Encryption) refers to an encryption technology and is an algorithm for encrypting data. After encryption, the cipher resource ciphertexts are signed by using the master station private key. A signing process is: S1=Sign(E1), and S2=Sign(E2), where S1 is the first signature, and S2 is the second signature. Finally, E1 and S1 are delivered to the Bluetooth device A, and E2 and S2 are delivered to the Bluetooth device B.

A device key is derivate by using the random number to generate the session key, the algorithm instance is generated based on device information and the random number, and the cipher resource is encrypted and signed, thereby ensuring confidentiality and integrity of transmission of the cipher resource.

In the above implementation process, the cipher resource application sent by the source Bluetooth device is obtained from the cipher resource management system, where the cipher resource application includes the information about the source Bluetooth device, the information about the destination Bluetooth device, and the plurality of random numbers; matching is performed in the preset application keys of the plurality of Bluetooth devices based on the information about the source Bluetooth device and the information about the destination Bluetooth device, to obtain the application key of the source Bluetooth device and the application key of the destination Bluetooth device; the cipher resource is generated based on the application key of the source Bluetooth device, the application key of the destination Bluetooth device, and the plurality of random numbers, where the cipher resource is used to generate the private address; the cipher resource is encrypted separately by using the application key of the source Bluetooth device and the application key of the destination Bluetooth device, to obtain the first cipher resource ciphertext and the second cipher resource ciphertext; the first cipher resource ciphertext and the second cipher resource ciphertext are separately signed based on the preset master station private key, to generate the first signature and the second signature; and the first signature and the first cipher resource ciphertext are delivered to the source Bluetooth device, and the second signature and the second cipher resource ciphertext are delivered to the destination Bluetooth device, so that the source Bluetooth device and the destination Bluetooth device perform Bluetooth communication based on the cipher resource. The cipher resource is obtained based on the random numbers and the application keys. Random numbers differ in each communication, and therefore, different cipher resources are obtained, so that different private addresses are generated in each communication, thereby reducing a risk of being attacked, and ensuring the security of Bluetooth communication. Through encryption and signing of the cipher resource, the confidentiality and the integrity of transmission of the cipher resource are ensured. A MAC address of conventional Bluetooth is usually allocated by a device manufacturer, and MAC addresses of different devices may conflict with each other, resulting in a communication fault. In this embodiment, the cipher resource is uniformly generated by using the cipher resource management system, so that such a conflict can be avoided, and compatibility between devices and communication stability can be improved. MAC addresses of conventional Bluetooth are limited. When a quantity of devices increases, the addresses may be insufficient. The cipher resource management system generates the cipher resource temporarily based on a service application. The cipher resource is released immediately after the service application expires. Theoretically, infinite device connections are supported.

The cipher resource includes a Z-algorithm instance. A cipher resource of a Z-algorithm instance based on a plurality of parameters (including information such as a device area, time, a unique identifier, a device machine code, a chip ID, and a Bluetooth module) can increase security of pairing negotiation for Bluetooth communication. The MAC addresses of the conventional Bluetooth are usually fixed, and an attacker can identify and attack a device by monitoring and analyzing Bluetooth communication traffic. If a key is generated by using a Bluetooth MAC address of the Z-algorithm instance, different private addresses can be generated during each communication, thereby reducing a risk of being attacked. The MAC address of the conventional Bluetooth is a unique identifier of a device, and the attacker can track a location and an activity of the device by tracking a MAC address of the device. If the Bluetooth MAC address of the Z-algorithm instance is used, the device can be prevented from being tracked, thereby enhancing privacy protection for a user.

It should be noted that the cipher resource management system is responsible for online distribution of the cipher resource. For the application scenario of power operation and maintenance, an initial Z-cipher algorithm instance is configured at delivery of a handset, a terminal, an electric meter, and another power equipment. The initial Z-cipher algorithm instance may be randomly allocated based on an area. During each operation and maintenance of communication, a Z-cipher algorithm of a terminal device is updated.

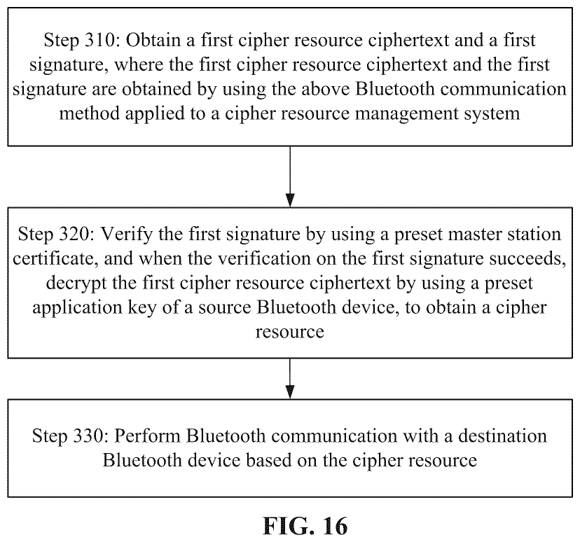

A Bluetooth communication method is further provided in this embodiment. As shown in FIG. 16, FIG. 16 schematically shows a schematic flowchart of a Bluetooth communication method applied to a source Bluetooth device according to an embodiment of the present disclosure. The Bluetooth communication method is applied to a source Bluetooth device and includes the following steps:
obtaining a cipher resource, where the cipher resource is obtained by using the above Bluetooth communication method applied to the cipher resource management system. Correspondingly, in some embodiments, when the cipher resource management system delivers the cipher resource to a Bluetooth device after encrypting and signing the cipher resource, the cipher resource is obtained.

In step 310, a first cipher resource ciphertext and a first signature are obtained, where the first cipher resource ciphertext and the first signature are obtained by using the above Bluetooth communication method applied to the cipher resource management system.

In step 320, the first signature is verified by using a preset master station certificate, and when the verification on the first signature succeeds, the first cipher resource ciphertext is decrypted by using a preset application key of a source Bluetooth device, to obtain a cipher resource.

The first cipher resource ciphertext is obtained by the cipher resource management system by encrypting the cipher resource by using the application key of the source Bluetooth device. The first signature is obtained by the cipher resource management system by signing the first cipher resource ciphertext based on a preset master station private key.

In this embodiment, the preset master station certificate is written into the Bluetooth device in advance, and is used to verify a signature. For ease of description of the solution, the Bluetooth device A and the Bluetooth device B are used as examples. The Bluetooth device A and the Bluetooth device B separately verify a signature for the cipher resource by using the master station certificate, that is, verify the first signature by using the preset master station certificate, and after the verification succeeds, decrypt the cipher resource separately by using an application key K_{A} and an application key K_{B}, to obtain a Z-algorithm instance Z1, a Z-algorithm instance Z2, a temporary key K1, a temporary key K2, and a session key K3.

In step 330, Bluetooth communication is performed with a destination Bluetooth device based on the cipher resource.

The cipher resource includes a Z-algorithm instance, a temporary key, and a session key, and a process of performing Bluetooth communication with the destination Bluetooth device includes the following:

First, a private address is constructed based on the Z-algorithm instance and the temporary key in the cipher resource.

Then, Bluetooth communication is performed with the destination Bluetooth device based on the private address by using the session key in the cipher resource.

In this embodiment, after the cipher resource is obtained, Bluetooth communication may be performed based on the cipher resource. In the above example, the Bluetooth device A generates a Bluetooth private address MAC_{A} based on the temporary key K1 and the Z-algorithm instance Z1, and the Bluetooth device B generates a Bluetooth private address MAC_{B} based on the temporary key K2 and the Z-algorithm instance Z2. The Bluetooth device A and the Bluetooth device B communicate with each other by using the session key K3 as the session key.

In some embodiments, the temporary key includes the temporary key K1 and the temporary key K2, and the Z-algorithm instance includes the Z-algorithm instance Z1 and the Z-algorithm instance Z2. The constructing the private address based on the Z-algorithm instance and the temporary key in the cipher resource includes the following steps:

In the first step, current local time and a region code are obtained, and a timestamp is generated based on the current local time.

In the second step, a random code formed by the timestamp and the region code is encrypted based on the temporary key K1 and the Z-algorithm instance Z1, to obtain an address encryption ciphertext of the source Bluetooth device.

In the third step, the random code formed by the timestamp and the region code is encrypted based on the temporary key K2 and the Z-algorithm instance Z2, to obtain an address encryption ciphertext of the destination Bluetooth device.

In the fourth step, a private address of the source Bluetooth device is constructed based on the address encryption ciphertext of the source Bluetooth device, the timestamp, and the region code.

In the fifth step, a private address of the destination Bluetooth device is constructed based on the address encryption ciphertext of the destination Bluetooth device, the timestamp, and the region code.

In this embodiment, an address of a Bluetooth device is a unique identifier of the device, a length of the address is 48 bits, and an address type and an address meaning are shown in Table 1.

TABLE 1
Resolution table for Bluetooth addresses

| Address | |
|---|---|
| [47:46] | Sub-type |
| 0b00 | Non-resolvable private address |
| 0b01 | Resolvable private address |
| 0b10 | Reserved field |
| 0b11 | Static address |

Private addresses include a non-resolvable private address and a resolvable private address. If the Bluetooth device uses a non-resolvable private address, the address needs to be changed each time the Bluetooth device is connected, and the address is more random, and therefore, privacy of the Bluetooth device can be protected, and the Bluetooth device is difficult to be tracked. To generate the resolvable private address, the device needs to have a local identity resolution key or a peer identity resolution key. The resolvable private address is generated by using a temporary key and a randomly generated 24-bit random number. Considering address compatibility, data with a length of 24 bits is generated by using a Z algorithm herein as a customized part of the non-resolvable private address. An address of the Bluetooth device is generated by using a specific Z-cipher algorithm, thereby providing a highly secure Bluetooth address generation solution, effectively preventing security threats such as network identity forgery and data redirection, and enhancing authenticity and credibility of a Bluetooth communication entity.

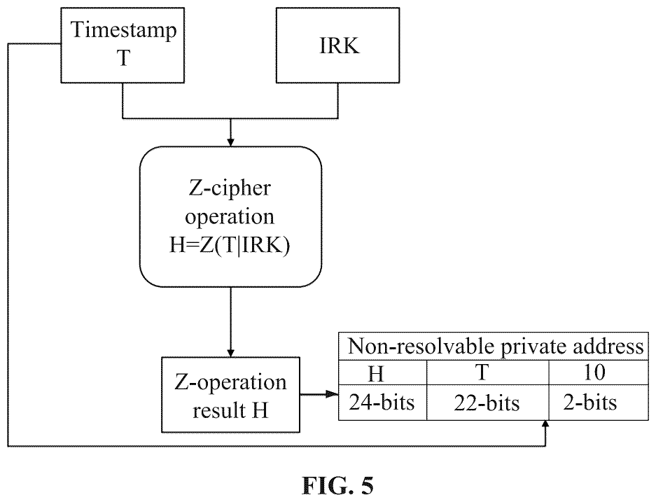

As shown in FIG. 5, FIG. 5 schematically shows a diagram of a process of generating a private address according to an embodiment of the present disclosure. IRK in the figure is an end key, and refers to the temporary keys K1 and K2 in the cipher resource. A 24-bit random number in the figure refers to time plus a region code used by a device, where a timestamp is 22 bits, and the region code is 2 bits. A 24-bit ciphertext is formed by encrypting the timestamp by using a Z-cipher operation. A 48-bit private address of Bluetooth is formed through summing up. Private addresses generated by the source Bluetooth device and the destination Bluetooth device are each 24-bit ciphertext+timestamp+region code.

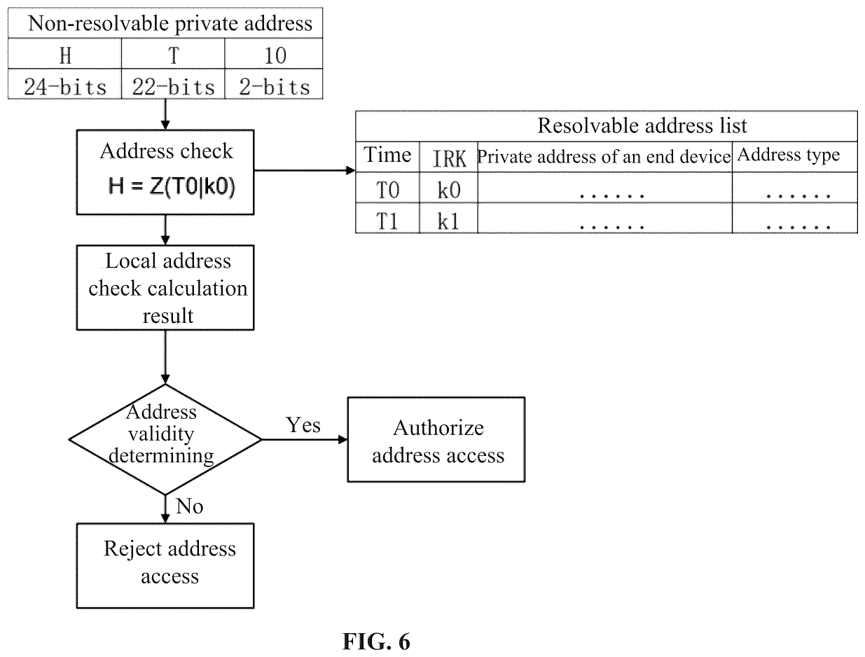

In some embodiments, as shown in FIG. 6, FIG. 6 schematically shows a diagram of a process of verifying a private address according to an embodiment of the present disclosure. The performing Bluetooth communication with the destination Bluetooth device based on the private address by using the session key in the cipher resource includes the following:

First, a connection establishment request is sent to the destination Bluetooth device based on the private address of the source Bluetooth device and the private address of the destination Bluetooth device.

Then, when the connection establishment request is successfully sent, a to-be-verified private address sent by the destination Bluetooth device is obtained.

Finally, validity verification is performed on the to-be-verified private address based on the cipher resource, and when the verification succeeds, Bluetooth communication is performed with the destination Bluetooth device by using the session key in the cipher resource.

In this embodiment, for a one-master multiple-slave scenario, a service device needs to establish an address resolution list, where the list mainly includes fields such as construction time, a Bluetooth device address resolution key (Identity Resolving Key, IRK), an identity address of an end device, and an address type. The Bluetooth device maintains, manages, and updates the list item based on a current session. Each timer after a data packet is received, validity of an address is verified first based on the address resolution list, and an unauthorized address is directly discarded. When two Bluetooth devices are connected to each other, validity resolution is performed on addresses of the two Bluetooth devices. If timestamp+region code of the ciphertext obtained through resolution is consistent with timestamp+region code of the plaintext, the verification succeeds.

The performing Bluetooth communication with the destination Bluetooth device by using the session key in the cipher resource when the verification succeeds includes: performing dynamic session key negotiation with the destination Bluetooth device by using the session key in the cipher resource to obtain a temporary session key; and establishing a secure communication channel based on the temporary session key, to perform Bluetooth communication. In this method, an appropriate encryption algorithm and the temporary session key can be used for encrypted transmission of data through an air interface, to ensure that data transmitted through Bluetooth communication is encrypted in a transmission process, thereby protecting confidentiality of the data.

In the above implementation process, the private address is constructed based on the address encryption ciphertext of the Bluetooth device, the timestamp, and the region code, so that system maintenance costs are reduced, high reliability and security are possessed, and a framework is flexible, and can adapt to different application scenarios and requirements. Through verification of the private address, verification of a source address can be strengthened, and a Bluetooth address disguised attack can be prevented, thereby improving security and reliability of Bluetooth communication. By incorporating the Z-cipher algorithm into a process of generating a Bluetooth address, security of a key in the Bluetooth device is ensured, thereby improving the security of key in the Bluetooth device. A mechanism of generating and authenticating the private address for a Z cipher is used. By incorporating the Z-cipher algorithm into the process of generating a Bluetooth address, the security of the key in the Bluetooth device is ensured while address authentication is resolved, so that address authentication and key exchange can be performed without exposing the private key, thereby effectively protecting security of the private key, and improving ease of use and maintainability of the device. This can adapt to different application scenarios and requirements, and can better meet requirements of different users.

By incorporating the Z-cipher algorithm into the process of generating a Bluetooth address, a key can be effectively obfuscated with an encryption and decryption algorithm, to ensure the security of the key in the Bluetooth device while resolving address authentication. The Z-cipher algorithm is a powerful encryption algorithm, is highly secure and aggressive, and can effectively protect the key in the Bluetooth device from being stolen or cracked. By using the mechanism of generating and authenticating the private address for a Z cipher, address authentication and key exchange can be performed without exposing the private key, thereby effectively protecting security of the private key. Compared with other solutions supported by security hardware, a Bluetooth address generation method using the Z-cipher algorithm reduces device maintenance costs, and does not require an additional hardware cipher module for easy deployment and maintenance. By using the mechanism of generating and authenticating the private address for a Z cipher, an address generation and authentication process of the Bluetooth device can be simplified, and ease of use and maintainability of the device can be improved.

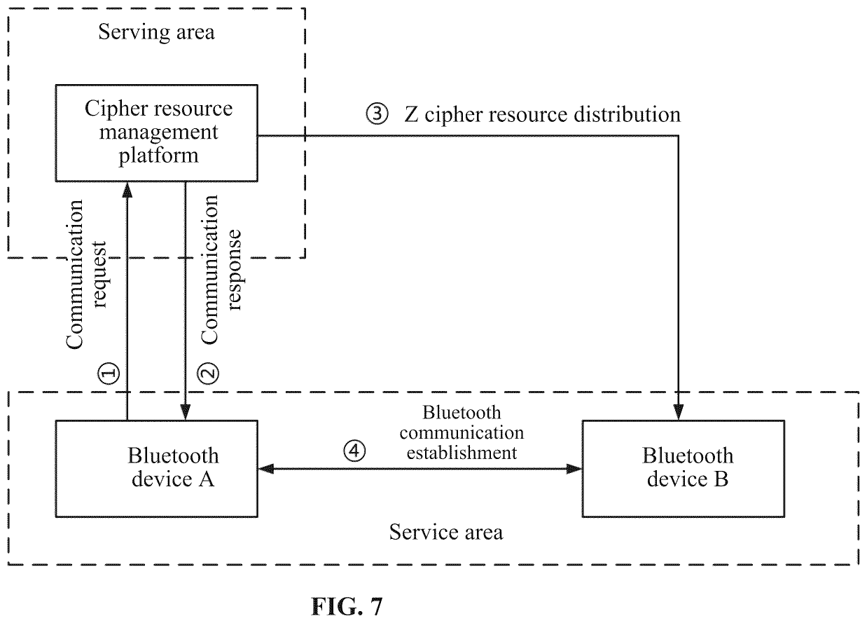

As shown in FIG. 7, FIG. 7 schematically shows a diagram of an architecture of generation of a Bluetooth private address according to an embodiment of the present disclosure. On the one hand, a cipher resource management platform provides a resource retrieval service for a Bluetooth device within a supervisory scope of the cipher resource management platform, and on the other hand, the cipher resource management platform is responsible for issuing a cipher resource required for generating a private address for the Bluetooth device.

A working principle of this framework is described below with reference to a scenario in which a Bluetooth device A accesses a Bluetooth device B.

Initial condition:
(1) An IP address of the cipher resource management platform is configured for the Bluetooth devices A and B.
(2) An initial Z-cipher algorithm instance is configured for the Bluetooth devices A and B.
(3) The Bluetooth devices A and B register with the cipher resource management platform and include device attribute information.

Process of generating a non-resolvable private address:
(1) The device A sends attribute information such as a geographical location and a communication request to the cipher resource management platform.
(2) The cipher resource management platform resolves request service information of the Bluetooth device A, and retrieves information about the Bluetooth device B based on a service.
(3) The cipher resource management platform generates Z-cipher resources Z1 and Z2 for the Bluetooth device A and the Bluetooth device B based on a cipher policy, and then distributes the cipher resources to the Bluetooth device A and the Bluetooth device B.
(4) After the Bluetooth device A and the Bluetooth device B receive the Z-cipher MAC resources, the Bluetooth device A generates a Bluetooth private address MAC_{A}=Enc(N, Z1) based on a Z-cipher algorithm, and the Bluetooth device B generates a host private address MAC_{B}=Enc(N, Z2), where N is a random code formed by a timestamp and a region code.
(5) When the Bluetooth device A accesses the Bluetooth device B, a dynamic address MAC_{B}=Enc(N, Z2) of the device B is calculated first, and then a destination address and a source address of a frame are respectively assigned with values MAC_{A} and MAC_{B}. A data packet is formed and sent to the Bluetooth device B. After receiving a data frame, the Bluetooth device B first verifies validity of an address based on a Z algorithm, and rejects access from an illegal address.

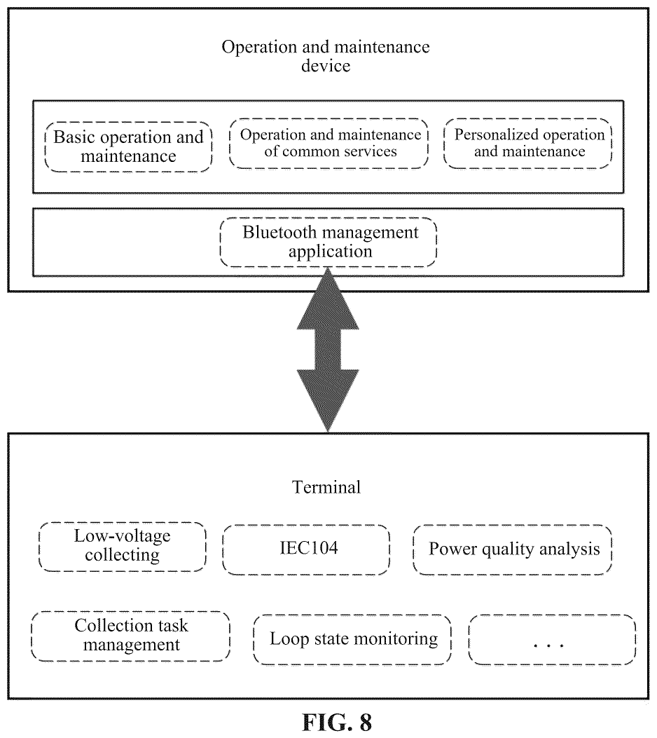

Establishment of a Bluetooth air interface secure communication channel is described below by using a specific usage scenario. A power operation and maintenance device (a mobile phone/handset) is a carrier of an application (APP) of an electric service, and a Bluetooth management application serves as a basic application, supports functions such as configuration management, data collection, electric meter Bluetooth detection, and inter-device communication interaction, and provides a callable secure air interface communication channel for another advanced service application. An operation and maintenance solution based on the Z algorithm is as follows: An operation and maintenance task of a master station is delivered to a maintenance device; the maintenance device is connected to a terminal through Bluetooth by using the Bluetooth management application; and based on a maintenance task, a maintenance region, and maintenance equipment authorization code, operation and maintenance personnel use a maintenance device to perform status query, parameter setting, control, and other operations on a power terminal through Bluetooth wireless communication. The operation and maintenance task delivered in cooperation with the master station improves operation and maintenance efficiency, and security authorization for the maintenance device and operation and maintenance record ensure security and traceability of an operation and maintenance operation. FIG. 8 shows an overall architecture of the operation and maintenance solution.

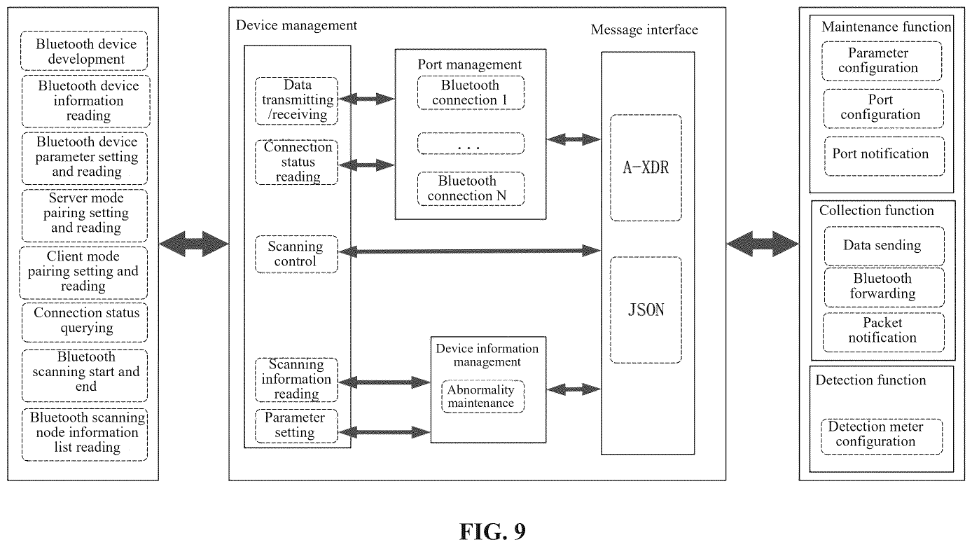

The Bluetooth management application is responsible for managing communication control of a Bluetooth channel of the operation and maintenance device. The Bluetooth channel supports multi-master multi-slave and multi-channel multi-connection. The same operation and maintenance device supports connections to a plurality of Bluetooth terminal devices. The Bluetooth management application provides a related service application with Bluetooth communication management interfaces in an A-XDR encoding rule and two JSON encoding formats. Functions such as Bluetooth parameter setting and data sending and receiving are implemented through a message interface. A Bluetooth management application software architecture is modularized based on functions, and is mainly divided into four parts: device management, port management, message management, and abnormality maintenance. As shown in FIG. 9, FIG. 9 schematically shows a schematic diagram of a Bluetooth management application software framework according to an embodiment of the present disclosure.

A device management module includes a device management task and a device operation interface. The device management task periodically updates a port link status by invoking a standard driver interface to read various status information of a Bluetooth device, reads port data, and distributes related data to a port queue. The device operation interface provides encapsulation of some operation interfaces of the Bluetooth device, including Bluetooth device parameter setting, Bluetooth module switching, port parameter configuration, port scanning startup, and Bluetooth device node information reading.

The port management module is mainly configured to manage a plurality of Bluetooth connections. A service application invokes a Bluetooth port configuration interface to trigger creation, and updates a status in a port maintenance module of a device management task. The device port mainly includes a master-slave mode, a port number, a connection status, a peer end address, and a buffer for received and sent data. According to a specification, a Bluetooth management application registers with a system management service through a message queuing telemetry transport (MQTT) message and responds to a common message such as heartbeat detection, to ensure a normal service status of an application. Based on priority fields of MQTT transmit/receive interface messages, a sequence of messages of different priorities is controlled through control of priorities of message queues.

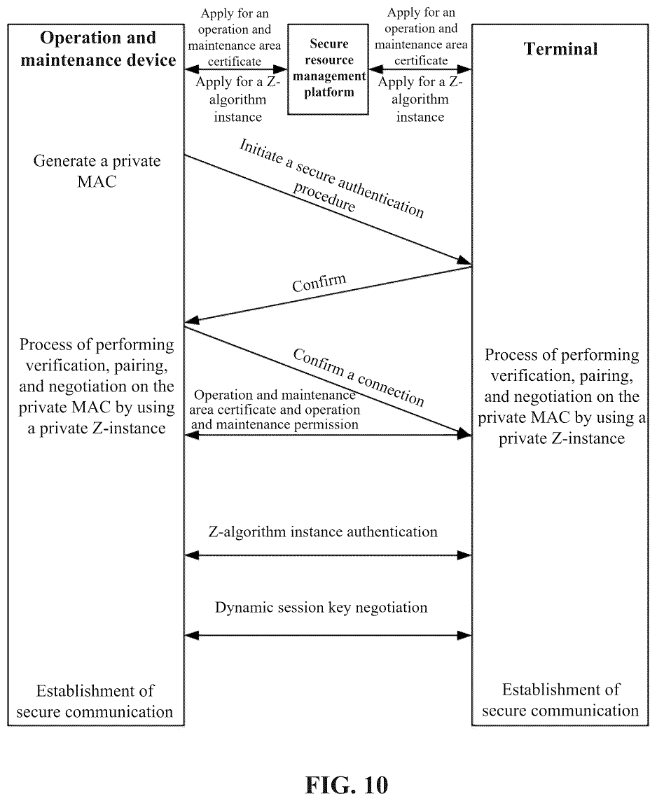

Abnormality maintenance is responsible for management of abnormality of a Bluetooth module or channel. The device management module synchronizes a connection status to an abnormality maintenance task. When continuous communication abnormalities occur, a power control interface is actively invoked to reset the module. A port connection status is monitored. When there is a long-term connection status abnormality or there is no data communication, a connection is actively disconnected, and the connection is scanned. When excessive ports are configured for a service application, the Bluetooth management application actively clears inactive port information to improve working efficiency. After an authentication connection is established between devices, a secure Bluetooth air interface encryption communication channel is established to ensure confidentiality and integrity of data transmission. As shown in FIG. 10, FIG. 10 schematically shows a process of establishing a secure communication channel according to an embodiment of the present disclosure.

An operation and maintenance device applies for an operation and maintenance area certificate and a Z-algorithm instance to a security resource management platform (a cipher resource management system is set in the security resource management platform). Request information carries a Bluetooth private address and geographical location information. The security resource management platform verifies validity of an operation and maintenance terminal address according to a policy, and issues the Z-algorithm instance to the operation and maintenance device and an electric power terminal after the verification succeeds. The operation and maintenance device and the electric power terminal start a process of verification and negotiation based on a private Z instance. After the authentication is completed, an initial communication connection is established. A Bluetooth module of the operation and maintenance device and a Bluetooth module of the electric power terminal send operation and maintenance area certificates and operation and maintenance permissions to each other for verification. After two-way authentication between the operation and maintenance device and the electric power terminal succeeds, data is encrypted and decrypted based on the authentication of the Z-algorithm instance and a temporary session key negotiated by using a dynamic session key, and finally a secure communication channel is established. An advanced service may choose a manner such as plaintext, ciphertext, plaintext+MAC, and ciphertext+MAC based on different data security levels, to securely transmit data.

A security authentication communication process is described below by using a specific application scenario.

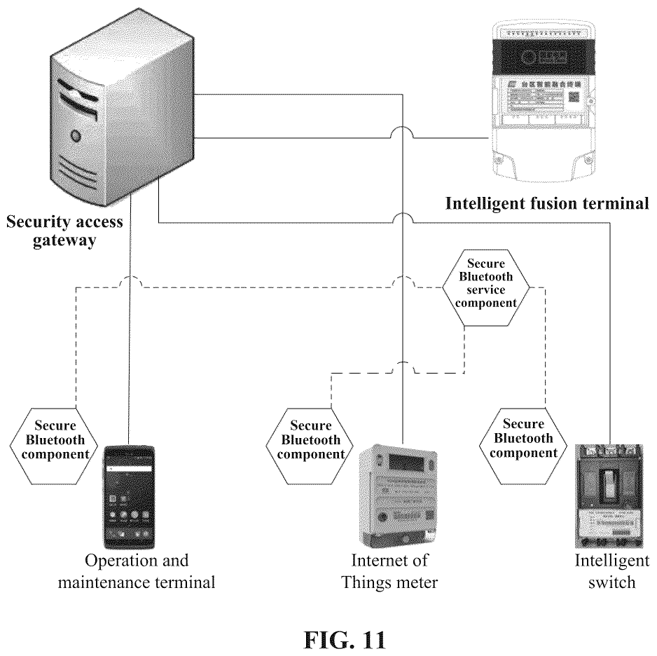

As shown in FIG. 11, FIG. 11 schematically shows a schematic diagram of an application scenario of operation and maintenance of intelligent power distribution according to an embodiment of the present disclosure. In a scenario of operation and maintenance of intelligent power distribution, an operation and maintenance terminal accesses a security access gateway in a 4G manner. The security access gateway is deployed with a Z-cipher resource management service program. The operation and maintenance terminal is deployed with a secure Bluetooth component. An intelligent convergence terminal, a power meter, and an intelligent switch can be deployed with a secure Bluetooth component. A specific secure authentication communication process is as follows:
Step 1: An operation and maintenance terminal sends an access request of a converged terminal to a security access gateway, where request information carries a Bluetooth private address and geographic location information.
Step 2: The security access gateway verifies validity of an address of the operation and maintenance terminal according to an access policy. If the address is invalid, access is rejected.
Step 3: The security access gateway retrieves an intelligent convergence terminal in an area in which the security access gateway is located, generates Z-algorithm instances for the intelligent convergence terminal and an operation and maintenance handset, and then distributes the Z-algorithm instances to the operation and maintenance handset and the convergence terminal.
Step 4: The operation and maintenance handset generates a private MAC address of the operation and maintenance handset and a private MAC address of the convergence terminal based on the received Z-algorithm instance, and initiates an access request to the intelligent convergence terminal based on the address.
Step 5: After receiving a requested packet, the convergence terminal validates validity of an address in a private address verification manner, and rejects access after the verification fails.
Step 6: After the verification of the validity of the address succeeds, dynamic session key negotiation is performed, and data is encrypted and decrypted based on a negotiated temporary session key, so that a secure channel is established.

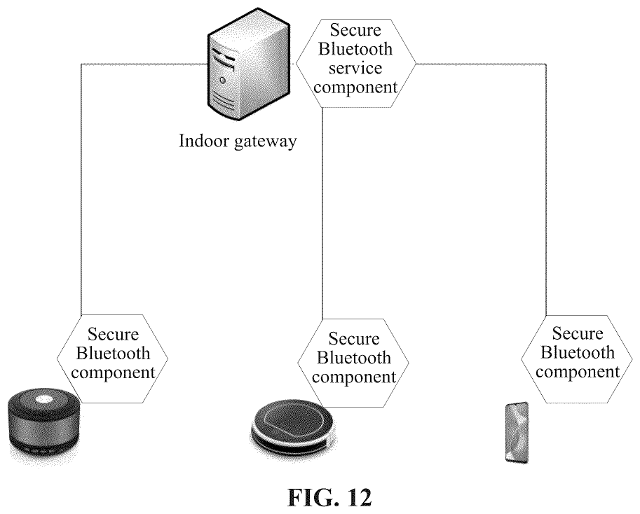

As shown in FIG. 12, FIG. 12 schematically shows a schematic diagram of an application scenario of home Bluetooth according to an embodiment of the present disclosure. An address generation and verification mechanism is deployed on all Bluetooth communication nodes. A secure Bluetooth service component is deployed on a home gateway. The secure Bluetooth service component is responsible for distributing Z-cipher algorithm instances required by all nodes in an internal network. In addition, the secure Bluetooth component is deployed on all nodes to implement a private address generation and verification function. Specific steps are as follows:
Step 1: Register with a secure Bluetooth service component for basic information of an accessed Bluetooth device (such as a Bluetooth sound box) in an internal network through management software.
Step 2: Install the secure Bluetooth component on each node, deploy an initial Z-cipher algorithm instance Z₁₀, and configure an address of an indoor gateway.
Step 3: When a Bluetooth device is connected through Bluetooth by using a mobile phone, the secure Bluetooth component initiates an access request Q1 to the indoor gateway, where a source address of a requested packet is MAC_{A1}=Enc(MAC₁, Z₁₀), and an Enc calculation result is a private address of MAC₁, and this operation is completed by the secure Bluetooth component. In addition, the requested packet may carry information such as a timestamp and a request type.
Step 4: After receiving the request Q1, the secure Bluetooth service component of the indoor gateway extracts a source MAC address from a data frame, and verifies validity of an address based on a Z-cipher algorithm. If an address verification result is valid, step 5 is performed. Otherwise, a further communication request is rejected, and access ends.
Step 5: The secure Bluetooth service component calculates MAC=Enc(MAC₃, Z₃₀) based on the address MAC₃ of the accessed Bluetooth device, where Z₃₀ is an initial Z-cipher algorithm instance of the accessed Bluetooth device.
Step 6: After receiving response information, the mobile phone may send a request to the Bluetooth device based on the allocated Z-algorithm instance. The Bluetooth device verifies validity of an address of an access device based on the distributed Z-algorithm instance. If the address is invalid, a connection is rejected.
Step 7: After the verification of the validity of the address succeeds, dynamic session key negotiation is performed, and data is encrypted and decrypted based on a negotiated temporary session key, so that a secure channel is established, and management and control by a device such as the mobile phone for an intelligent home device are implemented.

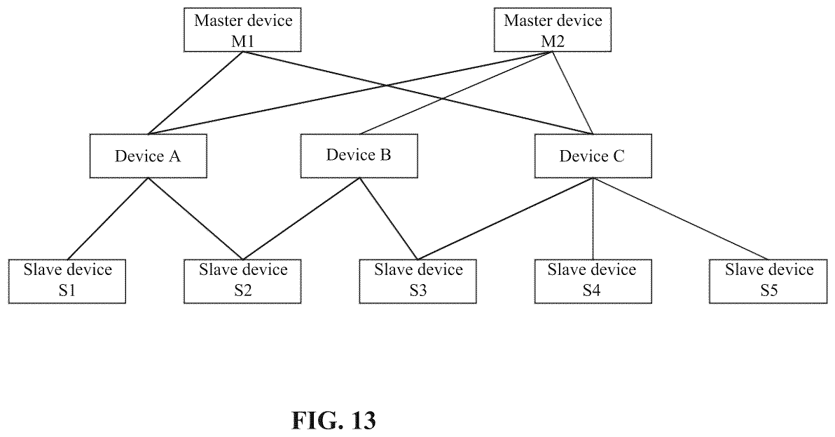

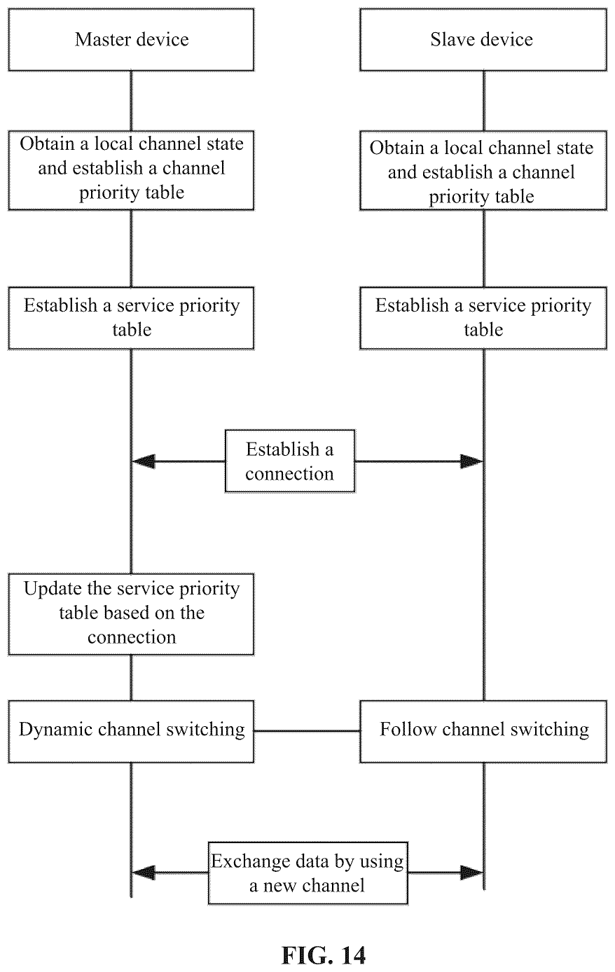

A multi-master multi-slave Bluetooth network includes a plurality of master devices and a plurality of slave devices. As shown in FIG. 13, FIG. 13 schematically shows a schematic diagram of an application scenario of a multi-master multi-slave Bluetooth network according to an embodiment of the present disclosure. It should be noted that, for ease of description of this solution, a master device in the figure corresponds to a source Bluetooth device, and a slave device corresponds to a destination Bluetooth device. This embodiment further provides a method for controlling, based on channel state information, a channel and a slot that are adjusted based on a service priority. As shown in FIG. 14, a master device and a slave device separately obtain a local channel state, and establish a channel priority table and a service priority table, and then a connection is established between the master device and the slave device. The master device updates the service priority table based on the connection, and then performs dynamic channel switching. Correspondingly, the slave device follows the channel switching, and then the master device and the slave device perform data interaction based on a new channel.

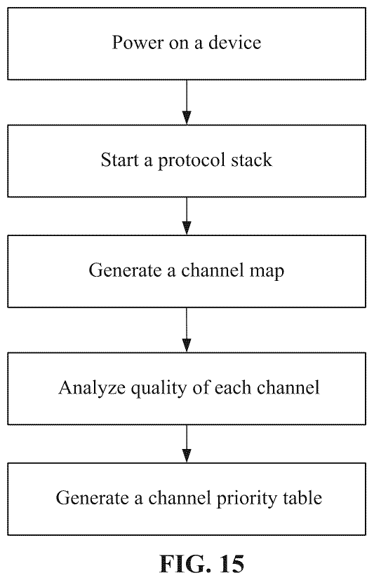

For a master device, as shown in FIG. 15, FIG. 15 schematically shows a flowchart of generating a channel priority table according to an embodiment of the present disclosure. In some embodiments, after the establishing the secure communication channel, the Bluetooth communication method further includes the following steps:

First, a local channel state is obtained, and a channel map and a channel priority table are obtained based on the local channel state.

In this embodiment, each Bluetooth device periodically analyzes each channel state to generate a channel map, and performs channel quality analysis on each signal, including signal quality, interference, and a noise level. Based on an analysis result, each Bluetooth device establishes a respective channel priority table, and the table records each channel priority sequence of the device. In the channel priority table, a device with higher channel quality has a higher priority, and can perform data transmission preferentially. A device with lower channel quality is arranged at a lower priority, and data transmission of the device may be delayed or a transmission rate is limited.

Then, service information of the master device is obtained, and a service priority table is established based on a service level and a service priority of the master device.

In this embodiment, after a connection is established, the Bluetooth device establishes the service priority table based on the service level and the service priority of the Bluetooth device, and service levels and service priorities of all connected Bluetooth devices are uniformly agreed, that is, a same service corresponds to a same service priority in different Bluetooth devices.

When establishing the service priority table, the master device takes into account the importance, urgency, and timeliness of different services, and formulates a corresponding priority sequence based on these factors. In the service priority table, a service of a higher priority receives more resources and attention to ensure timely and reliable handling. For a service with a lower priority, the master device may limit resource allocation of the service or arrange the service at a queue tail, to ensure normal execution of a service with a high priority. Through establishment of the service priority table, devices in the multi-master multi-slave Bluetooth network can be better managed, to ensure timely processing and execution of an important service, and improve efficiency and reliability of an entire network.

The method further includes: sending the channel map and the channel priority table to all Bluetooth devices in a network through broadcasting.

In this embodiment, in a multi-master and multi-slave Bluetooth network, each Bluetooth device sends the channel map and the channel priority table to all Bluetooth devices in the network through broadcasting, so that another device learns an available channel and a corresponding frequency hopping sequence. The channel map includes parameters such as a frequency range, a channel spacing, and a frequency hopping sequence of all available channels, so that the device can select an optimal channel for communication. In a broadcasting process, the device continuously broadcasts the channel map and the channel priority table to a surrounding area. After receiving the information, another device can store the information locally for use when necessary. Sending the channel map and the channel priority table in a broadcasting manner can promote communication and collaboration between devices in the multi-master multi-slave Bluetooth network, so that the network is more open and transparent, thereby improving efficiency and reliability of the entire network. The slave device selects a proper channel and a frequency hopping sequence based on the received channel map information to communicate with the master device.

In some embodiments, the Bluetooth communication method further includes the following steps:
first, selecting a data channel based on a channel selection algorithm;
then, obtaining current channel state information and current service information by using the data channel;
then, comparing the current channel state information with the channel priority table to obtain a priority of a current channel; and
finally, switching between service channels based on the priority of the current channel, the service priority table, and the current service information, to obtain a most appropriate channel.

The switching between the service channels based on the priority of the current channel, the service priority table, and the current service information, to obtain the most appropriate channel includes the following steps:

In the first step, a current service priority is obtained by querying the service priority table based on the current service information.

In the second step, whether the current service priority matches the priority of the current channel is determined.

In the third step, if it is determined that the current service priority matches the priority of the current channel, communication is performed by using the current channel.

In the fourth step, if it is determined that the current service priority does not match the priority of the current channel, a channel that matches the current service priority is selected from the channel priority table, and communication is performed by using the channel.

In this embodiment, after the connection is established between the master device and the slave device, the master device and the slave device first switch between channels based on a default CSA #2 channel switching protocol, and then exchange channel status information and current service information through a data channel. The master device compares a current channel with the channel priority table, to learn a priority of the current channel. Then, the service channel switching is performed based on channel priorities. The master device selects the most appropriate channel to communicate with the slave device. A channel switching process is: obtaining a priority of a current service by querying the service priority table, and then, selecting a channel that matches a priority of the service from the channel priority table based on the service priority. In this way, devices in the multi-master multi-slave Bluetooth network can be better managed, to ensure timely processing and execution of an important service, and improve efficiency and reliability of the entire network.

In some embodiments, the Bluetooth communication method further includes the following steps:
first, periodically obtaining a channel state, and updating the channel priority table based on the channel state to obtain a new channel priority table; and
then, broadcasting the new channel priority table, so that a connected Bluetooth device dynamically adjusts a frequency hopping channel based on the new channel priority table.

In this embodiment, after the connection is established between the master device and the slave device, each device periodically analyzes a channel state of the device, updates the channel priority table, and broadcasts the channel priority table. A connected master device dynamically adjusts a frequency hopping channel based on the updated channel priority table.

In some embodiments, the Bluetooth communication method further includes:
first, in a communication process, determining, based on a size of an exchanged data packet, whether to perform dynamic slot adjustment on current communication; and
then, when the size of the exchanged data packet is greater than a preset threshold, adjusting, based on a current service priority, a ratio of slots used for the current communication, to implement dynamic slot adjustment.

In this embodiment, after the connection is established between the master device and the slave device, the master device may further determine, based on a size of an exchanged data packet, whether to perform dynamic slot adjustment. If an amount of exchanged data is greater than a preset threshold, communication efficiency needs to be further improved, and the master device performs slot adjustment, and adjusts a ratio of slots used for current communication based on the current service priority, to perform dynamic allocation. If a relatively large quantity of devices are currently connected, no slot may be allocated to a connection of a low priority in a current slot, to ensure timely processing and execution of a connection of a high priority. This can improve efficiency and reliability of an entire network, and ensure timely processing and execution of an important service.

For ease of calculation, the adjusting a ratio of a slot used for current communication based on a current service priority specifically includes: generating a plurality of service weights based on the current service priority and the service priority table; and then, adjusting, based on a ratio of each service weight, the ratio of the slots used for the current communication, to implement dynamic adjustment of the slot.

In this embodiment, when a slot ratio is adjusted based on the service priority, it is not easy to perform quantization based on the priority. Therefore, the service weight is generated based on the service priority, and an algorithm for adjusting a slot length based on the weighted ratio may dynamically adjust the slot length based on a priority and a weighted ratio of a connection.

Specifically, the adjusting, based on a ratio of each service weight, the ratio of the slots used for the current communication includes:
first, initializing a total slot length;
then, separately calculating an adjusted slot length of each connection based on the ratio of each service weight and the total slot length; and
finally, updating a slot of each connection in the current communication based on the adjusted slot length of each connection, to adjust the ratio of the slots used for current communication.

In this embodiment, a total slot length TotalSlotLength is first initialized as a slot upper limit, and a default value of a weight sum TotalWeighted is 100. Then, a priority Priority_i of each connection is updated in real time based on the service priority table. A weighted ratio of each connection is calculated: WeightedRatio_i=Priority_i/TotalWeighted, where Priority_i is a weight of an i^{th} connection, and TotalWeighted is a sum of priority weights of all connections. A slot length of each adjusted connection slot is calculated: AdjustedSlotLength_i=TotalSlotLength*WeightedRatio_i. A slot of each connection is updated based on the calculated slot length of each connection. If a service changes, a slot length required by each connection needs to be recalculated, and the above adjustment process is performed.

In the above implementation process, the service priority table is generated based on the service priority, and is used to dynamically adjust a channel. Different channel priorities may be set based on different service types and requirements, to flexibly adjust channel resource allocation and adapt to various application scenarios. If a channel is adjusted based on a service priority, a channel resource can be used more efficiently, and communication efficiency and a data transmission rate are improved. Through adjustment of the channel priority, it can be ensured that better communication guarantee is granted for an important service, thereby improving stability and reliability of a system. The channel priority is dynamically adjusted based on an actual service requirement and a change in a network environment, thereby better adapting to an application scenario that changes in real time and improving adaptivity and intelligence of the system.

Compared with common slot adjustment, adjusting a slot based on a weight has the following technical advantages:
1. Flexibility: A slot length can be flexibly adjusted based on a priority and urgency of a task, to better adapt to various application scenarios and a task requirement that changes in real time.
2. Fairness: When a slot is adjusted based on a task weight, it can ensure that tasks have fair communication opportunities, to prevent some tasks from being affected by a communication conflict.
3. Efficiency: When a slot is adjusted based on a task weight, communication resources can be used more efficiently, system efficiency and performance can be improved, a low-priority service is prevented from occupying network resources, and efficiency and reliability of an entire network can be improved.
4. Reliability: When a slot is adjusted based on a task weight, it can be ensured that better communication guarantee is granted for an important task, thereby improving stability and reliability of a system.

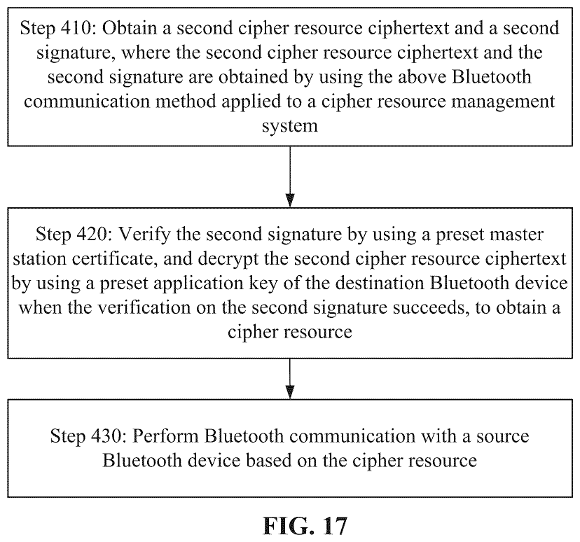

Corresponding to a source Bluetooth device, this embodiment further provides a Bluetooth communication method. As shown in FIG. 17, FIG. 17 schematically shows a schematic flowchart of a Bluetooth communication method applied to a destination Bluetooth device according to an embodiment of the present disclosure. The Bluetooth communication method is applied to a destination Bluetooth device and includes the following steps:
obtaining a cipher resource, where the cipher resource is obtained by using the above Bluetooth communication method applied to the cipher resource management system; and when a cipher resource is encrypted and signed by the cipher resource management system and then delivered to a Bluetooth device, obtaining the cipher resource.
In step 410, a second cipher resource ciphertext and a second signature are obtained, where the second cipher resource ciphertext and the second signature are obtained by using the above Bluetooth communication method applied to the cipher resource management system.
In step 420, the second signature is verified by using a preset master station certificate, and the second cipher resource ciphertext is decrypted by using a preset application key of the destination Bluetooth device when the verification on the second signature succeeds, to obtain a cipher resource.

The second cipher resource ciphertext is obtained by the cipher resource management system by encrypting the cipher resource by using the application key of the source Bluetooth device. The second signature is obtained by the cipher resource management system by signing the second cipher resource ciphertext based on a preset master station private key.

In this embodiment, the preset master station certificate is written into the Bluetooth device in advance, and is used to verify a signature. For ease of description of the solution, the Bluetooth device A and the Bluetooth device B are used as examples. The Bluetooth device A and the Bluetooth device B separately verify a signature for the cipher resource by using the master station certificate, that is, verify the first signature by using the preset master station certificate, and after the verification succeeds, decrypt the cipher resource separately by using an application key K_{A} and an application key K_{B}, to obtain a Z-algorithm instance Z1, a Z-algorithm instance Z2, a temporary key K1, a temporary key K2, and a session key K3.

In step 430, Bluetooth communication is performed with the source Bluetooth device based on the cipher resource.

This includes the following steps:
first, constructing a private address based on the Z-algorithm instance and the temporary key in the cipher resource; and
then, performing Bluetooth communication with the source Bluetooth device based on the private address by using the session key in the cipher resource.

In this embodiment, after the cipher resource is obtained, Bluetooth communication may be performed based on the cipher resource. In the above example, the Bluetooth device A generates a Bluetooth private address MAC_{A} based on the temporary key K1 and the Z-algorithm instance Z1, and the Bluetooth device B generates a Bluetooth private address MAC_{B} based on the temporary key K2 and the Z-algorithm instance Z2. The Bluetooth device A and the Bluetooth device B communicate with each other by using the session key K3 as the session key.

In some embodiments, the temporary key includes the temporary key K1 and the temporary key K2, and the Z-algorithm instance includes the Z-algorithm instance Z1 and the Z-algorithm instance Z2. The constructing the private address based on the Z-algorithm instance and the temporary key in the cipher resource includes the following steps:

In the first step, current local time and a region code are obtained, and a timestamp is generated based on the current local time.

In the second step, a random code formed by the timestamp and the region code is encrypted based on the temporary key K1 and the Z-algorithm instance Z1, to obtain an address encryption ciphertext of the source Bluetooth device.

In the third step, the random code formed by the timestamp and the region code is encrypted based on the temporary key K2 and the Z-algorithm instance Z2, to obtain an address encryption ciphertext of the destination Bluetooth device.

In the fourth step, a private address of the source Bluetooth device is constructed based on the address encryption ciphertext of the source Bluetooth device, the timestamp, and the region code.

In the fifth step, a private address of the destination Bluetooth device is constructed based on the address encryption ciphertext of the destination Bluetooth device, the timestamp, and the region code.

It should be noted that in this embodiment, a process of generating the private address is the same as a process of generating the private address in the source Bluetooth device, and details are not described herein again.

In some embodiments, the performing Bluetooth communication with the source Bluetooth device based on the private address by using the session key in the cipher resource includes:
first, obtaining, in response to a connection establishment request sent by the source Bluetooth device, a to-be-verified private address sent by the source Bluetooth device; and
then, verifying validity of the to-be-verified private address based on the cipher resource, and performing Bluetooth communication with the source Bluetooth device by using the session key in the cipher resource when the verification succeeds.

The performing Bluetooth communication with the source Bluetooth device based on the private address by using the session key in the cipher resource includes:

In a first step, dynamic session key negotiation is performed with the source Bluetooth device by using the session key in the cipher resource, to obtain a temporary session key.

In a second step, a secure communication channel is established based on the temporary session key, to perform Bluetooth communication.

It should be noted that, the above process of verifying the validity of the address is the same as a process of verifying the validity of the address in the source Bluetooth device, and details are not described herein again.

In some embodiments, after the establishing the secure communication channel, the method further includes:

First, a local channel state is obtained, and a channel map and a channel priority table are obtained based on the local channel state.

Then, service information of the destination Bluetooth device is obtained, and a service priority table is established based on a service level and a service priority of the destination Bluetooth device.

The method further includes: sending the channel map and the channel priority table to all Bluetooth devices in a network through broadcasting.

It should be noted that in this embodiment, the above process of establishing the channel map, the channel priority table, and the service priority table is the same as a process of establishing the channel map, the channel priority table, and the service priority table in the source Bluetooth device, and details are not described herein again.

In some embodiments, the method further includes the following steps:
first, periodically obtaining a channel state, and updating the channel priority table based on the channel state to obtain a new channel priority table; and
then, broadcasting the new channel priority table, so that a connected Bluetooth device dynamically adjusts a frequency hopping channel based on the new channel priority table.

It should be noted that, in this embodiment, a process of updating the channel priority table is the same as the process of updating the channel priority table in the source Bluetooth device, and details are not described herein again.

This embodiment further provides a Bluetooth communication system that includes a cipher resource management system, a source Bluetooth device, and a destination Bluetooth device.

The source Bluetooth device is configured to send a cipher resource application to the cipher resource management system, where the cipher resource application includes information about the source Bluetooth device, information about the destination Bluetooth device, and a plurality of random numbers.

The cipher resource management system is configured to: perform matching in preset application keys of a plurality of Bluetooth devices based on the information about the source Bluetooth device and the information about the destination Bluetooth device, to find an application key of the source Bluetooth device and an application key of the destination Bluetooth device; generate a cipher resource based on the application key of the source Bluetooth device, the application key of the destination Bluetooth device, and the plurality of random numbers, where the cipher resource is used to generate a private address; separately encrypt the cipher resource by using the application key of the source Bluetooth device and the application key of the destination Bluetooth device, to obtain a first cipher resource ciphertext and a second cipher resource ciphertext; separately sign the first cipher resource ciphertext and the second cipher resource ciphertext based on a preset master station private key, to generate a first signature and a second signature; and deliver the first signature and the first cipher resource ciphertext to the source Bluetooth device, and deliver the second signature and the second cipher resource ciphertext to the destination Bluetooth device, so that the source Bluetooth device and the destination Bluetooth device perform Bluetooth communication based on the cipher resource.

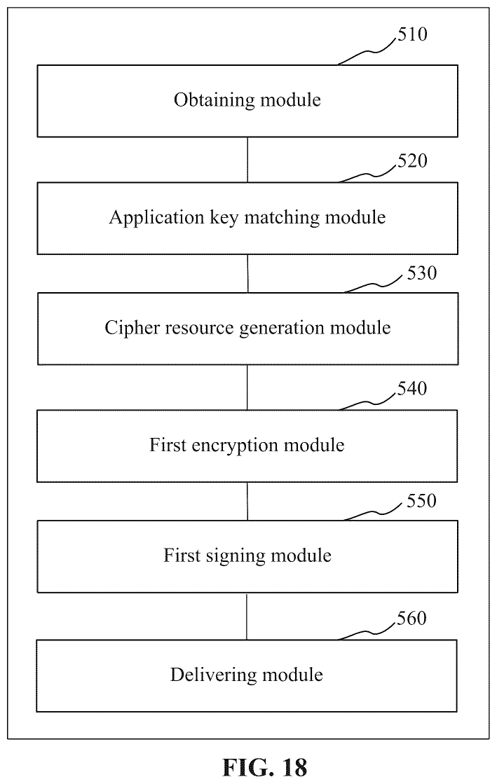

An embodiment further provides a Bluetooth communication apparatus. As shown in FIG. 18, FIG. 18 schematically shows a block diagram of a structure of a Bluetooth communication apparatus applied to a cipher resource management system according to an embodiment of the present disclosure. The Bluetooth communication apparatus is applied to a cipher resource management system, and the Bluetooth communication apparatus includes an obtaining module 510, an application key matching module 520, a cipher resource generation module 530, a first encryption module 540, a first signing module 550, and a delivering module 560.

The obtaining module 510 is configured to obtain a cipher resource application sent by a source Bluetooth device, where the cipher resource application includes information about the source Bluetooth device, information about a destination Bluetooth device, and a plurality of random numbers.

The application key matching module 520 is configured to perform matching in preset application keys of a plurality of Bluetooth devices based on the information about the source Bluetooth device and the information about the destination Bluetooth device, to find an application key of the source Bluetooth device and an application key of the destination Bluetooth device.
a cipher resource generation module 530 configured to generate a cipher resource based on the application key of the source Bluetooth device, the application key of the destination Bluetooth device, and the plurality of random numbers;
a first encryption module 540 configured to encrypt the cipher resource separately by using the application key of the source Bluetooth device and the application key of the destination Bluetooth device, to obtain a first cipher resource ciphertext and a second cipher resource ciphertext, where the cipher resource is used to generate a private address;
a first signing module 550 configured to separately sign the first cipher resource ciphertext and the second cipher resource ciphertext based on a preset master station private key, to generate a first signature and a second signature; and
a delivering module 560 configured to: deliver the first signature and the first cipher resource ciphertext to the source Bluetooth device, and deliver the second signature and the second cipher resource ciphertext to the destination Bluetooth device, so that the source Bluetooth device and the destination Bluetooth device perform Bluetooth communication based on the cipher resource.

The cipher resource generation module 530 includes:
a first key derivation unit configured to perform key derivation on the application key of the source Bluetooth device based on the first random number to obtain a temporary key K1;
a second key derivation unit configured to perform key derivation on the application key of the destination Bluetooth device based on the second random number to obtain a temporary key K2;
an algorithm instance unit configured to: generate a Z-algorithm instance Z1 based on the temporary key K1 by using a Z-cipher algorithm, and generate a Z-algorithm instance Z2 based on the temporary key K2 by using the Z-cipher algorithm;
a third key derivation unit configured to perform key derivation on the application key of the source Bluetooth device based on a secure chip sequence number of the destination Bluetooth device and the third random number, to obtain a session key; and
a resource generation unit configured to obtain the cipher resource based on the temporary key K1, the temporary key K2, the Z-algorithm instance Z1, the Z-algorithm instance Z2, and the session key.

The Bluetooth communication apparatus includes a processor and a memory. The obtaining module 510, the application key matching module 520, the cipher resource generation module 530, the first encryption module 540, the first signing module 550, and the delivering module 560 are stored in the memory as program units, and the processor executes the program units stored in the memory to implement corresponding functions.

The processor includes a kernel, and the kernel calls a corresponding program unit from the memory. One or more kernels may be disposed. A risk of being attacked is reduced by adjusting a kernel parameter, and the security of Bluetooth communication is ensured.

The memory may include a non-persistent memory, a random access memory (RAM), and/or a non-volatile memory in a computer-readable medium, such as a read-only memory (ROM) or a flash memory (flash RAM). The memory includes at least one storage chip.

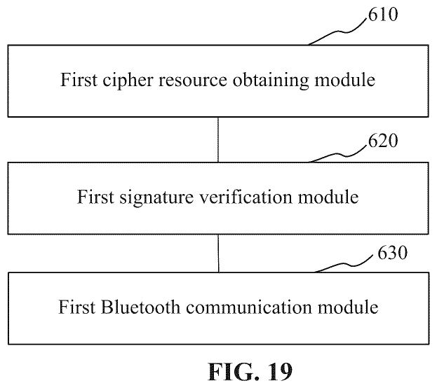

An embodiment provides a Bluetooth communication apparatus. As shown in FIG. 19, FIG. 19 schematically shows a block diagram of a structure of a Bluetooth communication apparatus applied to a source Bluetooth device according to an embodiment of the present disclosure. The Bluetooth communication apparatus is applied to a source Bluetooth device, and includes a first cipher resource obtaining module 610, a first signature verification module 620, and a first Bluetooth communication module 630.

The first cipher resource obtaining module 610 is configured to obtain a first cipher resource ciphertext and a first signature, where the first cipher resource ciphertext and the first signature are obtained by using the above Bluetooth communication apparatus applied to the cipher resource management system.

The first signature verification module 620 is configured to: verify the first signature by using a preset master station certificate, and decrypt the first cipher resource ciphertext by using a preset application key of the source Bluetooth device when the verification on the first signature succeeds, to obtain a cipher resource.

The first Bluetooth communication module 630 is configured to perform Bluetooth communication with a destination Bluetooth device based on the cipher resource.

The Bluetooth communication apparatus includes a processor and a memory. The first cipher resource obtaining module 610, the first signature verification module 620, the first Bluetooth communication module 630, and the like are stored in the memory as program units, and the processor executes the program units stored in the memory to implement corresponding functions.

The processor includes a kernel, and the kernel calls a corresponding program unit from the memory. One or more kernels may be disposed. A risk of being attacked is reduced by adjusting a kernel parameter, and the security of Bluetooth communication is ensured.

The memory may include a non-persistent memory, a random access memory (RAM), and/or a non-volatile memory in a computer-readable medium, such as a read-only memory (ROM) or a flash memory (flash RAM). The memory includes at least one storage chip.

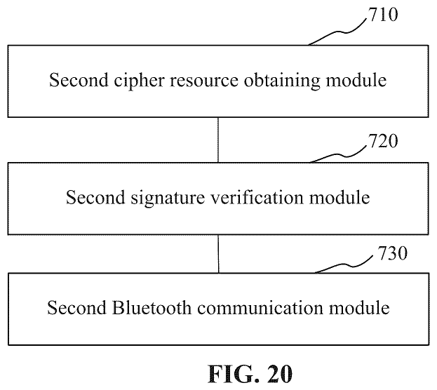

An embodiment provides a Bluetooth communication apparatus. As shown in FIG. 20, FIG. 20 schematically shows a block diagram of a structure of a Bluetooth communication apparatus applied to a destination Bluetooth device according to an embodiment of the present disclosure. The Bluetooth communication apparatus is applied to a destination Bluetooth device, and includes a second cipher resource obtaining module 710, a second signature verification module 720, and a second Bluetooth communication module 730.

The second cipher resource obtaining module 710 is configured to obtain a second cipher resource ciphertext and a second signature, where the second cipher resource ciphertext and the second signature are obtained by using the above Bluetooth communication apparatus applied to the cipher resource management system.

The second signature verification module 720 is configured to: verify the second signature by using a preset master station certificate, and decrypt the second cipher resource ciphertext by using a preset application key of the destination Bluetooth device when the verification on the second signature succeeds, to obtain a cipher resource.

The second Bluetooth communication module 730 is configured to perform Bluetooth communication with a source Bluetooth device based on the cipher resource.

The Bluetooth communication apparatus includes a processor and a memory. The second cipher resource obtaining module 710, the second signature verification module 720, the second Bluetooth communication module 730, and the like are stored in the memory as program units, and the processor executes the program units stored in the memory to implement corresponding functions.

The processor includes a kernel, and the kernel calls a corresponding program unit from the memory. One or more kernels may be disposed. A risk of being attacked is reduced by adjusting a kernel parameter, and the security of Bluetooth communication is ensured.

The memory may include a non-persistent memory, a random access memory (RAM), and/or a non-volatile memory in a computer-readable medium, such as a read-only memory (ROM) or a flash memory (flash RAM). The memory includes at least one storage chip.

An embodiment of the present disclosure further provides a machine-readable storage medium that stores a program. When the program is executed by a processor, the Bluetooth communication method is implemented.

An embodiment of the present disclosure provides a processor. The processor is configured to run a program, and when the program is run, the Bluetooth communication method is performed.

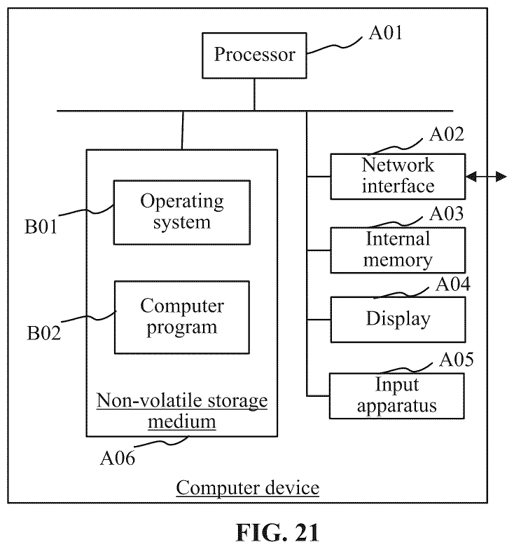

In an embodiment, a computer device is provided. The computer device may be a terminal, and an internal structure of the terminal may be as shown in FIG. 21. The computer device includes a processor A01, a network interface A02, a display A04, an input apparatus A05, and a memory (not shown in the figure) that are connected through a system bus. The processor A01 of the computer device is configured to provide computing and control capabilities. The memory of the computer device includes an internal memory A03 and a non-volatile storage medium A06. The non-volatile storage medium A06 stores an operating system B01 and a computer program B02. The internal memory A03 provides an environment for operation of the operating system B01 and the computer program B02 in the non-volatile storage medium A06.

The network interface A02 of the computer device is configured to communicate with an external terminal through a network. When the computer program is executed by the processor A01, a Bluetooth communication method is implemented. The display A04 of the computer device may be a liquid crystal display (LCD) or an e-ink display; the input apparatus A05 of the computer device may be a touch layer covering the display, or a key, a trackball, or a touchpad disposed on a housing of the computer device, an external keyboard, touchpad, mouse, or the like.

Those skilled in the art may understand that the structure shown in FIG. 21 is only a block diagram of a part of the structure related to the solutions of the present disclosure and does not constitute a limitation on a computer device to which the solutions of the present disclosure are applied. Specifically, the computer device may include more or less components than those shown in the figure, or combine some components, or have different component arrangements.

In an embodiment, the Bluetooth communication method provided in the present disclosure may be implemented in the form of a computer program. The computer program may be run on the computer device shown in FIG. 21. The memory of the computer device may store program modules that compose the Bluetooth communication apparatus. For example, a computer program including the obtaining module 510, the application key matching module 520, the cipher resource generation module 530, the first encryption module 540, the first signing module 550, and the delivering module 560 that are shown in FIG. 18, or the first cipher resource obtaining module 610, the first signature verification module 620, and the first Bluetooth communication module 630 that are shown in FIG. 19, or the second cipher resource obtaining module 710, the second signature verification module 720, and the second Bluetooth communication module 730 that are shown in FIG. 20 enables the processor to perform the steps in the Bluetooth communication methods in the embodiments of the present disclosure described in this specification.

The computer device shown in FIG. 21 may perform step 210 by using the obtaining module 510 in the Bluetooth communication apparatus shown in FIG. 18. The computer device may perform step 220 by using the application key matching module 520, perform step 230 by using the cipher resource generation module 530, perform step 240 by using the first encryption module 540, perform step 250 by using the first signing module 550, and perform step 260 by using the delivering module 560.

The computer device shown in FIG. 21 may perform step 310 by using the first cipher resource obtaining module 610 in the Bluetooth communication apparatus shown in FIG. 19. The computer device may perform step 320 by using the first signature verification module 620, and the computer device may perform step 330 by using the first Bluetooth communication module 630.

The computer device shown in FIG. 21 may perform step 410 by using the second cipher resource obtaining module 710 in the Bluetooth communication apparatus shown in FIG. 20. The computer device may perform step 420 by using the second signature verification module 720. The computer device may perform step 430 by using the second Bluetooth communication module 730.

An embodiment of the present disclosure further provides an electronic device. The electronic device includes at least one processor, and a memory connected to the at least one processor. The memory stores an instruction that can be executed by the at least one processor, and the at least one processor executes the instruction stored in the memory to implement the above Bluetooth communication method. When executing the instruction, the processor implements the following steps:
obtaining a cipher resource application sent by a source Bluetooth device, where the cipher resource application includes information about the source Bluetooth device, information about a destination Bluetooth device, and a plurality of random numbers;
performing matching in preset application keys of a plurality of Bluetooth devices based on the information about the source Bluetooth device and the information about the destination Bluetooth device, to find an application key of the source Bluetooth device and an application key of the destination Bluetooth device;
generating a cipher resource based on the application key of the source Bluetooth device, the application key of the destination Bluetooth device, and the plurality of random numbers;
encrypting the cipher resource separately by using the application key of the source Bluetooth device and the application key of the destination Bluetooth device, to obtain a first cipher resource ciphertext and a second cipher resource ciphertext;
separately signing the first cipher resource ciphertext and the second cipher resource ciphertext based on a preset master station private key, to generate a first signature and a second signature; and
delivering the first signature and the first cipher resource ciphertext to the source Bluetooth device, and delivering the second signature and the second cipher resource ciphertext to the destination Bluetooth device, so that the source Bluetooth device and the destination Bluetooth device perform Bluetooth communication based on the cipher resource; where
the cipher resource is used to generate a private address.

In an embodiment, secure chip sequence numbers of a plurality of Bluetooth devices are preset in the cipher resource management system, the plurality of random numbers include a first random number, a second random number, and a third random number, and the cipher resource includes a Z-algorithm instance, a temporary key, and a session key.

The generating the cipher resource based on the application key of the source Bluetooth device, the application key of the destination Bluetooth device, and the plurality of random numbers includes:
performing key derivation on the application key of the source Bluetooth device based on the first random number to obtain a temporary key K1;
performing key derivation on the application key of the destination Bluetooth device based on the second random number to obtain a temporary key K2;
generating a Z-algorithm instance Z1 based on the temporary key K1 by using a Z-cipher algorithm, and generating a Z-algorithm instance Z2 based on the temporary key K2 by using the Z-cipher algorithm;
performing key derivation on the application key of the source Bluetooth device based on a secure chip sequence number of the destination Bluetooth device and the third random number to obtain the session key; and
obtaining the cipher resource based on the temporary key K1, the temporary key K2, the Z-algorithm instance Z1, the Z-algorithm instance Z2, and the session key.

In an embodiment, a process of obtaining the preset application keys of the plurality of Bluetooth devices includes:
obtaining the plurality of Bluetooth devices through registration, and separately obtaining secure chip information of the Bluetooth devices, where the secure chip information includes at least the secure chip sequence numbers; and
performing key derivation on the secure chip sequence numbers of the Bluetooth devices based on a preset service root key, to obtain the application keys of the plurality of Bluetooth devices.

A Bluetooth communication method is applied to a source Bluetooth device and includes:
obtaining a first cipher resource ciphertext and a first signature, where the first cipher resource ciphertext and the first signature are obtained by using the above Bluetooth communication method applied to the cipher resource management system;
verifying the first signature by using a preset master station certificate, and decrypting the first cipher resource ciphertext by using a preset application key of the source Bluetooth device when the verification on the first signature succeeds, to obtain a cipher resource; and
performing Bluetooth communication with a destination Bluetooth device based on the cipher resource.

In an embodiment, the performing Bluetooth communication with the destination Bluetooth device based on the cipher resource includes:
constructing a private address based on the Z-algorithm instance and the temporary key in the cipher resource; and
performing Bluetooth communication with the destination Bluetooth device based on the private address by using the session key in the cipher resource.

In an embodiment, the temporary key includes a temporary key K1 and a temporary key K2, and the Z-algorithm instance includes a Z-algorithm instance Z1 and a Z-algorithm instance Z2; and
the constructing the private address based on the Z-algorithm instance and the temporary key in the cipher resource includes:
obtaining current local time and a region code, and generating a timestamp based on the current local time;
encrypting, based on the temporary key K1 and the Z-algorithm instance Z1, a random code formed by the timestamp and the region code, to obtain an address encryption ciphertext of the source Bluetooth device;
encrypting, based on the temporary key K2 and the Z-algorithm instance Z2, the random code formed by the timestamp and the region code, to obtain an address encryption ciphertext of the destination Bluetooth device;
constructing a private address of the source Bluetooth device based on the address encryption ciphertext of the source Bluetooth device, the timestamp, and the region code; and
constructing a private address of the destination Bluetooth device based on the address encryption ciphertext of the destination Bluetooth device, the timestamp, and the region code.

In an embodiment, the performing Bluetooth communication with the destination Bluetooth device based on the private address by using the session key in the cipher resource includes:
sending a connection establishment request to the destination Bluetooth device based on the private address of the source Bluetooth device and the private address of the destination Bluetooth device;
when the connection establishment request is successfully sent, obtaining a to-be-verified private address sent by the destination Bluetooth device; and
verifying validity of the to-be-verified private address based on the cipher resource, and performing Bluetooth communication with the destination Bluetooth device by using the session key in the cipher resource when the verification succeeds.

In an embodiment, the performing Bluetooth communication with the destination Bluetooth device by using the session key in the cipher resource includes:
performing dynamic session key negotiation with the destination Bluetooth device by using the session key in the cipher resource, to obtain a temporary session key; and
establishing a secure communication channel based on the temporary session key, to perform Bluetooth communication.

In an embodiment, after the establishing the secure communication channel, the method further includes:
obtaining a local channel state, and constructing a channel map and a channel priority table based on the local channel state;
obtaining service information of the source Bluetooth device, and constructing a service priority table based on a service level and a priority of the source Bluetooth device.

In an embodiment, the method further includes:
sending the channel map and the channel priority table to all Bluetooth devices in a network through broadcasting.

In an embodiment, the method further includes:
selecting a data channel based on a channel selection algorithm;
obtaining current channel state information and current service information by using the data channel;
comparing the current channel state information with the channel priority table to obtain a priority of a current channel; and
switching between service channels based on the priority of the current channel, the service priority table, and the current service information, to obtain a most appropriate channel.

In an embodiment, the switching between the service channels based on the priority of the current channel, the service priority table, and the current service information, to obtain the most appropriate channel includes:
obtaining a current service priority by querying the service priority table based on the current service information;
determining whether the current service priority matches the priority of the current channel; and
if it is determined that the current service priority matches the priority of the current channel, performing communication by using the current channel; or
if it is determined that the current service priority does not match the priority of the current channel, selecting a channel that matches the current service priority from the channel priority table, and performing communication by using the channel.

In an embodiment, the method further includes:
periodically obtaining a channel state, and updating the channel priority table based on the channel state to obtain a new channel priority table; and
broadcasting the new channel priority table, so that a connected Bluetooth device dynamically adjusts a frequency hopping channel based on the new channel priority table.

In an embodiment, the method further includes:
in a communication process, determining, based on a size of an exchanged data packet, whether to perform dynamic slot adjustment on current communication; and
when the size of the exchanged data packet is greater, adjusting, based on a current service priority, a ratio of slots used for the current communication, to implement dynamic slot adjustment.

In an embodiment, the adjusting, based on the current service priority, the ratio of the slots used for the current communication, to implement dynamic slot adjustment includes:
generating a plurality of service weights based on the current service priority and the service priority table; and
adjusting, based on a ratio of each service weight, the ratio of the slots used for the current communication, to implement dynamic slot adjustment.

In an embodiment, the adjusting, based on the ratio of each service weight, the ratio of the slots used for the current communication includes:
initializing a total slot length;
separately calculating an adjusted slot length of each connection based on the ratio of each service weight and the total slot length; and
updating a slot of each connection in the current communication based on the adjusted slot length of each connection, to adjust the ratio of the slots used for the current communication.

A Bluetooth communication method is applied to a destination Bluetooth device and includes:
obtaining a second cipher resource ciphertext and a second signature, where the second cipher resource ciphertext and the second signature are obtained by using the above Bluetooth communication method applied to the cipher resource management system;
verifying the second signature by using a preset master station certificate, and decrypting the second cipher resource ciphertext by using a preset application key of the destination Bluetooth device when the verification on the second signature succeeds, to obtain a cipher resource; and
performing Bluetooth communication with a source Bluetooth device based on the cipher resource.

In an embodiment, the performing Bluetooth communication with the source Bluetooth device based on the cipher resource includes:
constructing a private address based on the Z-algorithm instance and the temporary key in the cipher resource; and
performing Bluetooth communication with the source Bluetooth device based on the private address by using the session key in the cipher resource.

In an embodiment, the temporary key includes a temporary key K1 and a temporary key K2, and the Z-algorithm instance includes a Z-algorithm instance Z1 and a Z-algorithm instance Z2; and
the constructing the private address based on the Z-algorithm instance and the temporary key in the cipher resource includes:
obtaining current local time and a region code, and generating a timestamp based on the current local time;
encrypting, based on the temporary key K1 and the Z-algorithm instance Z1, a random code formed by the timestamp and the region code, to obtain an address encryption ciphertext of the source Bluetooth device;
encrypting, based on the temporary key K2 and the Z-algorithm instance Z2, the random code formed by the timestamp and the region code, to obtain an address encryption ciphertext of the destination Bluetooth device;
constructing a private address of the source Bluetooth device based on the address encryption ciphertext of the source Bluetooth device, the timestamp, and the region code; and
constructing a private address of the destination Bluetooth device based on the address encryption ciphertext of the destination Bluetooth device, the timestamp, and the region code.

In an embodiment, the performing Bluetooth communication with the source Bluetooth device based on the private address by using the session key in the cipher resource includes:
obtaining, in response to a connection establishment request sent by the source Bluetooth device, a to-be-verified private address sent by the source Bluetooth device; and
verifying validity of the to-be-verified private address based on the cipher resource, and performing Bluetooth communication with the source Bluetooth device by using the session key in the cipher resource when the verification succeeds.

In an embodiment, the performing Bluetooth communication with the source Bluetooth device by using the session key in the cipher resource includes:
performing dynamic session key negotiation with the source Bluetooth device by using the session key in the cipher resource, to obtain a temporary session key; and
establishing a secure communication channel based on the temporary session key, to perform Bluetooth communication.

In an embodiment, after the establishing the secure communication channel, the method further includes:
obtaining a local channel state, and constructing a channel map and a channel priority table based on the local channel state; and
obtaining service information of the destination Bluetooth device, and constructing a service priority table based on a service level and a priority of the destination Bluetooth device.

In an embodiment, the method further includes:
sending the channel map and the channel priority table to all Bluetooth devices in a network through broadcasting.

In an embodiment, the method further includes:
periodically obtaining a channel state, and updating the channel priority table based on the channel state to obtain a new channel priority table; and
broadcasting the new channel priority table, so that a connected Bluetooth device dynamically adjusts a frequency hopping channel based on the new channel priority table.

Those skilled in the art should understand that the embodiments of the present disclosure may be provided as a method, a system, or a computer program product. Therefore, the present application can take the form of an entire hardware embodiment, an entire software embodiment, or an embodiment combining software and hardware. Moreover, the present disclosure may be in a form of a computer program product that is implemented on one or more computer-usable storage media (including but not limited to a magnetic disk memory, a CD-ROM, an optical memory, and the like) that include computer-usable program code.

The present disclosure is described with reference to the flowcharts and/or block diagrams of the method, the device (system), and the computer program product according to the embodiments of the present disclosure. It should be understood that each flow and/or block in the flowchart and/or block diagram and a combination of the flow and/or block in the flowchart and/or block diagram can be implemented by computer program instructions. These computer program instructions may be provided for a processor of a general-purpose computer, a special-purpose computer, an embedded processor, or other programmable data processing devices to produce a machine, such that instructions executed by the processor of the computer or other programmable data processing devices produce an apparatus used for implementing a function specified in one or more flows of the flowchart and/or one or more blocks of the block diagram.

These computer program instructions may be stored in a computer-readable memory that can instruct a computer or another programmable data processing device to work in a specific manner, such that the instructions stored in the computer-readable memory generate an artifact that includes an instruction apparatus. The instruction apparatus implements a specific function in one or more processes in the flowcharts and/or in one or more blocks in the block diagrams.

These computer program instructions may be alternatively loaded onto a computer or another programmable data processing device, such that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more processors (CPU), an input/output interface, a network interface, and a memory.

The memory may include a non-persistent memory, a random access memory (RAM) and/or a non-volatile memory in a computer-readable medium, such as a read-only memory (ROM) or a flash RAM (flash RAM). The memory is an example of a computer-readable medium.

The computer-readable medium includes both persistent, non-persistent, removable, and non-removable media, and storage of information may be implemented by any method or technology. The information may be computer-readable instructions, data structures, modules of programs, or other data. Examples of a computer storage medium include, but are not limited to, a phase-change random access memory (PRAM), a static random access memory (SRAM), a dynamic random access memory (DRAM), other types of RAMs, a ROM, an electrically erasable programmable read-only memory (EEPROM), a flash memory or another memory technology, a compact disc read-only memory (CD-ROM), a digital versatile disk (DVD) or another optical storage device, a magnetic cassette tape, and a magnetic tape disk storage device or another magnetic storage device or any other non-transmission medium, which can be used to store information that can be accessed by a computing device. The computer-readable medium, as defined herein, excludes transitory computer-readable media, such as modulated data signals and carriers.

It should also be noted that the term “comprise”, “include”, or any other variant thereof is intended to encompass a non-exclusive inclusion, such that a process, method, product, or device that includes a series of elements includes not only those elements, but also other elements not explicitly listed, or elements that are inherent to such a process, method, product, or device. Without more restrictions, an element defined by the phrase “including a . . . ” does not exclude the presence of another same element in a process, method, product, or device that includes the element.

The above described are merely embodiments of the present disclosure, which are not intended to limit the present disclosure. Various changes and modifications can be made to the present disclosure by those skilled in the art. Any modifications, equivalent replacements, and improvements made within the spirit and principle of the present application should be included within the protection scope of the claims of the present application.

1. A Bluetooth communication method, applied to a cipher resource management system, wherein the Bluetooth communication method comprises:
obtaining a cipher resource application sent by a source Bluetooth device, wherein the cipher resource application comprises information about the source Bluetooth device, information about a destination Bluetooth device, and a plurality of random numbers;
performing matching in preset application keys of a plurality of Bluetooth devices based on the information about the source Bluetooth device and the information about the destination Bluetooth device, to find an application key of the source Bluetooth device and an application key of the destination Bluetooth device;
generating a cipher resource based on the application key of the source Bluetooth device, the application key of the destination Bluetooth device, and the plurality of random numbers;
encrypting the cipher resource separately by using the application key of the source Bluetooth device and the application key of the destination Bluetooth device, to obtain a first cipher resource ciphertext and a second cipher resource ciphertext;
separately signing the first cipher resource ciphertext and the second cipher resource ciphertext based on a preset master station private key, to generate a first signature and a second signature; and
delivering the first signature and the first cipher resource ciphertext to the source Bluetooth device, and delivering the second signature and the second cipher resource ciphertext to the destination Bluetooth device, so that the source Bluetooth device and the destination Bluetooth device perform Bluetooth communication based on the cipher resource; wherein
the cipher resource is used to generate a private address.

2. The Bluetooth communication method according to claim 1, wherein secure chip sequence numbers of a plurality of Bluetooth devices are preset in the cipher resource management system, the plurality of random numbers comprise a first random number, a second random number, and a third random number, and the cipher resource comprises a Z-algorithm instance, a temporary key, and a session key; and
the generating the cipher resource based on the application key of the source Bluetooth device, the application key of the destination Bluetooth device, and the plurality of random numbers comprises:
performing key derivation on the application key of the source Bluetooth device based on the first random number to obtain a temporary key K1;
performing key derivation on the application key of the destination Bluetooth device based on the second random number to obtain a temporary key K2;
generating a Z-algorithm instance Z1 based on the temporary key K1 by using a Z-cipher algorithm, and generating a Z-algorithm instance Z2 based on the temporary key K2 by using the Z-cipher algorithm;
performing key derivation on the application key of the source Bluetooth device based on a secure chip sequence number of the destination Bluetooth device and the third random number to obtain the session key; and
obtaining the cipher resource based on the temporary key K1, the temporary key K2, the Z-algorithm instance Z1, the Z-algorithm instance Z2, and the session key.

3. The Bluetooth communication method according to claim 1, wherein a process of obtaining the preset application keys of the plurality of Bluetooth devices comprises:
obtaining the plurality of Bluetooth devices through registration, and separately obtaining secure chip information of the Bluetooth devices, wherein the secure chip information comprises at least the secure chip sequence numbers; and
performing key derivation on the secure chip sequence numbers of the Bluetooth devices based on a preset service root key, to obtain the application keys of the plurality of Bluetooth devices.

4. A Bluetooth communication method, applied to a source Bluetooth device and comprising:
obtaining a first cipher resource ciphertext and a first signature, wherein the first cipher resource ciphertext and the first signature are obtained by using the Bluetooth communication method according to claim 1;
verifying the first signature by using a preset master station certificate, and decrypting the first cipher resource ciphertext by using a preset application key of the source Bluetooth device when the verification on the first signature succeeds, to obtain a cipher resource; and
performing Bluetooth communication with a destination Bluetooth device based on the cipher resource.

5. The Bluetooth communication method according to claim 4, wherein the cipher resource comprises a Z-algorithm instance, a temporary key, and a session key; and
the performing Bluetooth communication with the destination Bluetooth device based on the cipher resource comprises:
constructing a private address based on the Z-algorithm instance and the temporary key in the cipher resource; and
performing Bluetooth communication with the destination Bluetooth device based on the private address by using the session key in the cipher resource.

6. The Bluetooth communication method according to claim 5, wherein the temporary key comprises a temporary key K1 and a temporary key K2, and the Z-algorithm instance comprises a Z-algorithm instance Z1 and a Z-algorithm instance Z2; and
the constructing the private address based on the Z-algorithm instance and the temporary key in the cipher resource comprises:
obtaining current local time and a region code, and generating a timestamp based on the current local time;
encrypting, based on the temporary key K1 and the Z-algorithm instance Z1, a random code formed by the timestamp and the region code, to obtain an address encryption ciphertext of the source Bluetooth device;
encrypting, based on the temporary key K2 and the Z-algorithm instance Z2, the random code formed by the timestamp and the region code, to obtain an address encryption ciphertext of the destination Bluetooth device;
constructing a private address of the source Bluetooth device based on the address encryption ciphertext of the source Bluetooth device, the timestamp, and the region code; and
constructing a private address of the destination Bluetooth device based on the address encryption ciphertext of the destination Bluetooth device, the timestamp, and the region code.

7. The Bluetooth communication method according to claim 6, wherein the performing Bluetooth communication with the destination Bluetooth device based on the private address by using the session key in the cipher resource comprises:
sending a connection establishment request to the destination Bluetooth device based on the private address of the source Bluetooth device and the private address of the destination Bluetooth device;
when the connection establishment request is successfully sent, obtaining a to-be-verified private address sent by the destination Bluetooth device; and
verifying validity of the to-be-verified private address based on the cipher resource, and performing Bluetooth communication with the destination Bluetooth device by using the session key in the cipher resource when the verification succeeds.

8. The Bluetooth communication method according to claim 7, wherein the performing Bluetooth communication with the destination Bluetooth device by using the session key in the cipher resource when the verification succeeds comprises:
performing dynamic session key negotiation with the destination Bluetooth device by using the session key in the cipher resource, to obtain a temporary session key; and
establishing a secure communication channel based on the temporary session key, to perform Bluetooth communication.

9. The Bluetooth communication method according to claim 8, after the establishing the secure communication channel, further comprising:
obtaining a local channel state, and constructing a channel map and a channel priority table based on the local channel state; and
obtaining service information of the source Bluetooth device, and constructing a service priority table based on a service level and a priority of the source Bluetooth device.

10. The Bluetooth communication method according to claim 9, further comprising:
sending the channel map and the channel priority table to all Bluetooth devices in a network through broadcasting.

11. The Bluetooth communication method according to claim 9, further comprising:
selecting a data channel based on a channel selection algorithm;
obtaining current channel state information and current service information by using the data channel;
comparing the current channel state information with the channel priority table to obtain a priority of a current channel; and
switching between service channels based on the priority of the current channel, the service priority table, and the current service information, to obtain a most appropriate channel; and
the switching between the service channels based on the priority of the current channel, the service priority table, and the current service information, to obtain the most appropriate channel comprises:
obtaining a current service priority by querying the service priority table based on the current service information;
determining whether the current service priority matches the priority of the current channel; and
if it is determined that the current service priority matches the priority of the current channel, performing communication by using the current channel; or
if it is determined that the current service priority does not match the priority of the current channel, selecting a channel that matches the current service priority from the channel priority table, and performing communication by using the channel.

12. (canceled)

13. The Bluetooth communication method according to claim 9, further comprising:
periodically obtaining a channel state, and updating the channel priority table based on the channel state to obtain a new channel priority table; and
broadcasting the new channel priority table, so that a connected Bluetooth device dynamically adjusts a frequency hopping channel based on the new channel priority table.

14. The Bluetooth communication method according to claim 9, further comprising:
in a communication process, determining, based on a size of an exchanged data packet, whether to perform dynamic slot adjustment on current communication; and
when the size of the exchanged data packet is greater than a preset threshold, adjusting, based on a current service priority, a ratio of slots used for the current communication, to implement dynamic slot adjustment.

15. The Bluetooth communication method according to claim 14, wherein the adjusting, based on the current service priority, the ratio of the slots used for the current communication, to implement dynamic slot adjustment comprises:
generating a plurality of service weights based on the current service priority and the service priority table; and
adjusting, based on a ratio of each service weight, the ratio of the slots used for the current communication, to implement dynamic slot adjustment; and
the adjusting, based on the ratio of each service weight, the ratio of the slots used for the current communication comprises:
initializing a total slot length;
separately calculating an adjusted slot length of each connection based on the ratio of each service weight and the total slot length; and
updating a slot of each connection in the current communication based on the adjusted slot length of each connection, to adjust the ratio of the slots used for the current communication.

16. (canceled)

17. A Bluetooth communication method, applied to a destination Bluetooth device and comprising:
obtaining a second cipher resource ciphertext and a second signature, wherein the second cipher resource ciphertext and the second signature are obtained by using the Bluetooth communication method according to claim 1;
verifying the second signature by using a preset master station certificate, and decrypting the second cipher resource ciphertext by using a preset application key of the destination Bluetooth device when the verification on the second signature succeeds, to obtain a cipher resource; and
performing Bluetooth communication with a source Bluetooth device based on the cipher resource.

18. The Bluetooth communication method according to claim 17, wherein the cipher resource comprises a Z-algorithm instance, a temporary key, and a session key; and
the performing Bluetooth communication with the source Bluetooth device based on the cipher resource comprises:
constructing a private address based on the Z-algorithm instance and the temporary key in the cipher resource; and
performing Bluetooth communication with the source Bluetooth device based on the private address by using the session key in the cipher resource; and
the temporary key comprises a temporary key K1 and a temporary key K2, and the Z-algorithm instance comprises a Z-algorithm instance Z1 and a Z-algorithm instance Z2; and
the constructing the private address based on the Z-algorithm instance and the temporary key in the cipher resource comprises:
obtaining current local time and a region code, and generating a timestamp based on the current local time;
encrypting, based on the temporary key K1 and the Z-algorithm instance Z1, a random code formed by the timestamp and the region code, to obtain an address encryption ciphertext of the source Bluetooth device;
encrypting, based on the temporary key K2 and the Z-algorithm instance Z2, the random code formed by the timestamp and the region code, to obtain an address encryption ciphertext of the destination Bluetooth device;
constructing a private address of the source Bluetooth device based on the address encryption ciphertext of the source Bluetooth device, the timestamp, and the region code; and
constructing a private address of the destination Bluetooth device based on the address encryption ciphertext of the destination Bluetooth device, the timestamp, and the region code.

19. (canceled)

20. The Bluetooth communication method according to claim 18, wherein the performing Bluetooth communication with the source Bluetooth device based on the private address by using the session key in the cipher resource comprises:
obtaining, in response to a connection establishment request sent by the source Bluetooth device, a to-be-verified private address sent by the source Bluetooth device; and
verifying validity of the to-be-verified private address based on the cipher resource, and performing Bluetooth communication with the source Bluetooth device by using the session key in the cipher resource when the verification succeeds; and
the performing Bluetooth communication with the source Bluetooth device by using the session key in the cipher resource when the verification succeeds comprises:
performing dynamic session key negotiation with the source Bluetooth device by using the session key in the cipher resource, to obtain a temporary session key; and
establishing a secure communication channel based on the temporary session key, to perform Bluetooth communication; and
after the establishing the secure communication channel, the method further comprises:
obtaining a local channel state, and constructing a channel map and a channel priority table based on the local channel state; and
obtaining service information of the destination Bluetooth device, and constructing a service priority table based on a service level and a priority of the destination Bluetooth device.

21. (canceled)

22. (canceled)

23. The Bluetooth communication method according to claim 20, further comprising:
sending the channel map and the channel priority table to all Bluetooth devices in a network through broadcasting.

24. The Bluetooth communication method according to claim 20, further comprising:
periodically obtaining a channel state, and updating the channel priority table based on the channel state to obtain a new channel priority table; and
broadcasting the new channel priority table, so that a connected Bluetooth device dynamically adjusts a frequency hopping channel based on the new channel priority table.

25. A Bluetooth communication system, comprising a cipher resource management system, a source Bluetooth device, and a destination Bluetooth device, wherein
the source Bluetooth device is configured to send a cipher resource application to the cipher resource management system, wherein the cipher resource application comprises information about the source Bluetooth device, information about the destination Bluetooth device, and a plurality of random numbers; and
the cipher resource management system is configured to: perform matching in preset application keys of a plurality of Bluetooth devices based on the information about the source Bluetooth device and the information about the destination Bluetooth device, to find an application key of the source Bluetooth device and an application key of the destination Bluetooth device; generate a cipher resource based on the application key of the source Bluetooth device, the application key of the destination Bluetooth device, and the plurality of random numbers; encrypt the cipher resource separately by using the application key of the source Bluetooth device and the application key of the destination Bluetooth device, to obtain a first cipher resource ciphertext and a second cipher resource ciphertext; separately sign the first cipher resource ciphertext and the second cipher resource ciphertext based on a preset master station private key, to generate a first signature and a second signature; and deliver the first signature and the first cipher resource ciphertext to the source Bluetooth device, and deliver the second signature and the second cipher resource ciphertext to the destination Bluetooth device, so that the source Bluetooth device and the destination Bluetooth device perform Bluetooth communication based on the cipher resource; wherein the cipher resource is used to generate a private address.

26. (canceled)

27. (canceled)

28. (canceled)

29. (canceled)

30. (canceled)

31. (canceled)
